(19) United States
(12) Patent Application Publication
(10) Pub. No.: US 2020/0392283 A1
(43) Pub. Date: Dec. 17, 2020

(54) THERMOSET POLYMER NETWORKS, SHAPE MEMORY POLYMERS INCLUDING THERMOSET POLYMER NETWORKS, AND METHODS OF MAKING

(71) Applicant: Board of Supervisors of Louisiana State University and Agricultural and Mechanical College, Baton Rouge, LA (US)

(72) Inventors: Jizhou FAN, Baton Rouge, LA (US); Guoqiang LI, Baton Rouge, LA (US)

(21) Appl. No.: 16/960,609

(22) PCT Filed: Jan. 11, 2019
(86) PCT No.: PCT/US19/13178

§ 371 Date: Jul. 8, 2020

Related U.S. Application Data
(60) Provisional application No. 62/616,470, filed on Jan. 12, 2018.

(51) Int. Cl. C08G 59/50; C09K 8/88; C08G 59/24

(52) U.S. Cl. CPC C08G 59/5033; C08G 59/5026; C09K 8/88; C08G 2280/00; C09K 2208/08; C09K 2208/10; C08G 59/24

(57) ABSTRACT

Shape memory polymers (SMP), methods of making shape memory polymers, and articles including shape memory polymers are provided. The SMPs include thermoset polymer networks formed from an epoxy and a diamine. The SMPs can be in particle form and can be added to other materials while maintaining expansion capabilities. Articles formed from the SMPs can include rebar.

### CROSS-REFERENCE TO RELATED APPLICATIONS

This application claims the benefit of and priority to U.S. Provisional Application Ser. No. 62/616,470, having the title “THERMOSET POLYMER NETWORKS, SHAPE MEMORY POLYMERS INCLUDING THERMOSET POLYMER NETWORKS, AND METHODS OF MAKING”, filed on Jan. 12, 2018, the disclosure of which is incorporated herein by reference in its entirety.

### STATEMENT REGARDING FEDERALLY SPONSORED RESEARCH OR DEVELOPMENT

This invention was made with Government support under contract CMMI1333997 awarded by the National Science Foundation and contract NNX16AQ93A awarded by the National Aeronautics and Space Administration. The Government has certain rights in the invention.

### BACKGROUND

Shape memory polymers (SMPs) have been a topic of intensive research for years. In addition to shape memory, which means a deformed temporary shape can return to its original permanent shape upon stimulation, such as heat, light, moisture, pH, etc., SMPs can also release stress if free shape recovery is not allowed. The fact that SMPs can memorize both shape and stress has rendered them with many potential applications such as actuators, self-healing, sealants, proppants, expandable aggregates, morphing structures, stent, suture, soft robot, smart textile, rebar, etc. While many stimuli approaches have been used in SMPs such as host-guest transition, anisotropic-isotropic transition, etc., thermal transition has been the most popular method because some other methods such as electricity and magnetic field also cause indirect heating. Heat induced shape memory effect is triggered primarily by glass/vetrification transition and melt/crystallization transition. For thermally triggered SMPs, a bottleneck is the low recovery stress. There are several thermoset SMP systems cited as having very high stabilized recovery stress in the literature, of which, the majority exhibit stabilized recovery stress from tenths MPa to several MPa. However, in many applications, higher recovery stress is needed, or higher recovery stress leads to better results such as higher healing efficiency in self-healing applications.

For classical SMPs with glass transitions, entropy has been identified as the driving force for shape or stress recovery. During the transition from glassy state to rubbery state for amorphous thermoset polymers, it is not uncommon to see one to two orders decrease in the modulus of the polymers. The dramatic reduction in modulus through the transition is necessary for the SMP to demonstrate excellent shape recovery; however, it sacrifices stress recovery. The flexible rubbery state suggests that the SMP can only release a low stress. In other words, for higher recovery stress, the SMP in rubbery state must be stiffer; however, it may suffer from lower shape memory. Therefore, for entropy driven SMPs with thermal transitions, the contradictory requirement between recovery strain and recovery stress renders most thermoset SMPs with excellent shape memory but poor stress memory. Hence, it is a challenge to increase the stress memory while maintaining excellent shape memory.

### SUMMARY

Embodiments of the present disclosure provide for compositions including shape memory polymers, thermoset polymer networks, methods of making thermoset polymer networks, articles including thermoset polymer networks or shape memory polymers, and methods of making such articles.

An embodiment of the present disclosure includes a composition that includes a shape memory polymer having the characteristic of having an energy stored through an enthalpy increase. Said enthalpy increase is the result of stretched bonds during programming of the shape memory polymer. The shape memory polymer can have a recovery stress of about 15 to about 20 MPa, an energy output of about 2.0 to about 2.5 MJ/m³, and/or energy output efficiency of about 50% or greater.

An embodiment of the present disclosure includes a thermoset polymer network, the network including a product made by the reaction of an epoxy and an amine. An embodiment of the present disclosure includes a thermoset polymer network, including an epoxy moiety and an amine moiety. In such embodiments, the epoxy or epoxy moiety can be a bisphenol A-based epoxy resin. The amine or amine moiety can be 5-Amino-1,3,3-trimethylcyclohexanemethylamine, 1,5,5-trimethyl-1,3-Cyclohexanedimethanamine, 3-amino-4-5-6-trimethyl-Cyclohexanemethanamine, 4,6-dimethyl-1,3-Benzenedimethanamine, 5-methyl-1,3-Benzenedimethanamine, 4,4′-methylenebis[2,5-dimethyl-Cyclohexanamine], 4,4′-(1-methylethylidene) bis[2,6-dimethyl-Cyclohexanamine], 3,7-dimethyl-1,5-Naphthalenediamine 4,4′-(1-methylethylidene) bis-Benzenamine, 2,5-Diaminotoluene, 4,4-Methylenebis(2-methylcyclohexylamine, 4,4-Methylenebis(cyclohexylamine), 4,4′-Methylenebis(2-methylcyclohexylamine), 1,8-Diamino-p-menthane, Diaminonaphthalene, Diaminophenanthrene, Diaminophenazine, o-Phenylenediamine, p-Phenylenediamine, m-Phenylenediamine, N-Phenyl-o-phenylenediamine, N-Phenyl-benzene-1,3-diamine, N-Phenyl-p-phenylenediamine, N,N-Diphenyl-p-phenylenediamine, or 1,2,4,5-Benzenetetramine.

An embodiment of the present disclosure includes methods of making a thermoset polymer network, which includes mixing an epoxy and a diamine, and curing the mixture.

An embodiment of the present disclosure includes articles having shape memory. The articles can include a thermoset polymer network as above. The article can have a recovery stress of about 15 MPa to 20 MPa.

An embodiment of the present disclosure includes a method of making an article. The method can include mixing an epoxy and a diamine, forming the mixture into a shape; and curing the mixture.

An embodiment of the present disclosure includes a method of making a shape memory composite, by compressing a thermoset polymer network of the present disclosure at a temperature of about 140° C. to 170° C. to form a shape memory polymer in a programmed state. The method further includes cooling the shape memory polymer, and forming smaller particles of the shape memory polymer by such as breaking, crushing, or milling.

Other compositions, articles, methods, features, and advantages will be or become apparent to one with skill in the art upon examination of the following drawings and detailed description. It is intended that all such additional compositions, apparatus, methods, features and advantages be included within this description, be within the scope of the present disclosure, and be protected by the accompanying claims.

### BRIEF DESCRIPTION OF THE DRAWINGS

Further aspects of the present disclosure will be more readily appreciated upon review of the detailed description of its various embodiments, described below, when taken in conjunction with the accompanying drawings.

FIGS. 1.1A-1.1D show example stress and energy storage and recovery behavior for the high enthalpy storage thermoset shape memory polymer. FIG. 1.1A shows the fully constrained stress recovery profile in rubbery state. FIG. 1.1B shows the relationship between the recovery stress and recovery strain (the recovery stress was taken at 1.5 hours). FIG. 1.1C shows the stepwise iso-strain programming profile. FIG. 1.1D shows the change of programming stress after relaxation, or stored stress, with programming strain.

FIGS. 1.2A-1.2B are examples of testing and confirmation for the enthalpy release during the free shape recovery process by DSC. FIG. 1.2A shows the DSC test results for the original SMP after the synthesis. FIG. 1.2B shows the DSC test results for the 40% compressive strain programmed sample.

FIGS. 1.3A-1.3B show examples of the energetical, structural and conformational characteristics during compression deformation. FIG. 1.3A demonstrates the energetical evolution corresponding to linear zone I (LZ1), transition zone (TZ) and linear zone II (LZ2). FIG. 1.3B shows the structural and conformational evolution corresponding to LZ1, TZ and LZ2.

FIGS. 1.4A-1.4B illustrate the “multiple energy well” model for amorphous thermoset shape memory polymers. FIG. 1.4A illustrates programming. During programming at temperature above the glass transition zone, the network climbs up an energy hill with local energy well (or dip) (blue line) for local, meta-stale states. At the end of programming (after cooling and unloading), a deep energy well (dashed green line) is formed and thus the network is in a locked, non-equilibrium state. FIG. 1.4B illustrates recovery. Energy input, such as heating, is needed to drive the cold energy well (dashed green line) back to the hot energy well (solid blue line) and help the CSBs (red circles) jump out of the final energy well, roll down the energy hill, and achieve shape recovery without external constraint, or stress recovery with external constraint.

FIG. 1.5 shows the molecular structure of example chemicals for the reaction for synthesizing a thermoset shape memory polymer of the present disclosure.

FIGS. 1.6A-1.6B show a possible reaction pathway for the EPON-IPD network. The FIG. 1.6A presents how one amino group reacts with an epoxy group. FIG. 1.6B shows the network formed by nine EPON 826 and three IPD molecules. The stars indicate the extension of the rest of the network.

FIGS. 1.7A-1.7B provide potential molecular structures of amides that can produce enthalpy storage for new thermoset polymer networks. FIG. 1.7C shows using carbon nanotube (CNT) or carbon black as the rigid center.

FIG. 1.8 shows the DSC data profile for Synthesized EPON-IPD polymer network. The upper figure represents the heating curve and the lower one is cooling. The glass transition zone is identified between 140° C. and 160° C.

FIG. 1.9 illustrates the first and the second heat flow curve during heating for the programmed sample with 40% pre-strain and the baseline correction. The baseline of the heat release can be separated into two portions which are shifting baseline curve and the glass transition baseline.

FIG. 1.10 is an example of dynamic mechanical analysis profile for storage modulus, loss modulus and tan δ against the temperature scanned from room temperature to 150° C.

FIG. 1.11 is an example of a thermal expansion test performed by DMA.

FIGS. 1.12A-1.12D show prepared samples and the free shape recovery test. FIG. 1.12A is an example of the cut and milled cuboid samples. FIG. 1.12B shows the sample before the compression programming, which shows that the side length of the cuboid sample is 7.01 mm. FIG. 1.12C shows the sample after programming, which is compressed by 40% strain, and the height of the cuboid sample is 4.18 mm after load removal, which translates to a shape fixity ratio of about 100%. FIG. 1.12D shows the sample after the free shape recovery, almost fully restoring the original permanent shape (the side length becomes 7.00 mm after free shape recovery as compared to original length of 7.01 mm).

FIG. 1.13 shows the relationship between stress-strain-temperature during the compressive programming at 170° C. (step 1), the stress relaxation at 170° C. (step 2) and the cooling and unloading process (step 3).

FIG. 1.14 shows the development of recovery stress with time for the EPON-IPD specimen after 10% tensile programming.

FIG. 1.15 shows the recovery stress development with time at 170° C. (in rubbery state) for the specimen programmed at 150° C. (within glass transition region).

FIG. 1.16 shows the recovery stress of the programmed specimens with a fixed strain of 32% programmed at different temperatures. The recovery process was performed at the same temperature in rubbery state (170° C.).

FIGS. 1.17A-1.17B show the stress relaxation profile (normalized stress with time) for EPON-IPD polymer network under different temperatures (FIG. 1.17A linear scale and FIG. 1.17B logarithmic scale).

FIGS. 1.18A-1.18D show the relationship between the stress and strain for stepwise programming and the corresponding relaxed stress by different deformation strain rates (FIG. 1.18A strain rate, 10% per minute; FIG. 1.18B strain rate, 25% per minute;

FIG. 1.18C strain rate, 50% per minute). FIG. 1.18D shows the relaxed stress or stored stress for each step of the three different stepwise programming.

FIG. 1.19 is a compression stress-strain curve for the EPON-IPD polymer network at room temperature (glassy state).

FIG. 1.20A shows the relationship between stress and strain during the tensile test for a rectangular EPON-IPD specimen at 170° C. FIG. 1.208 provides example images of a specimen before and after the tensile programming and the specimen after recovery with 10% programming strain.

FIGS. 1.21A-1.21B illustrate an iso-strain compression and relaxation experiment. The engineering stress is against strain (FIG. 1.21A) and time (FIG. 1.21B).

FIGS. 1.22A-1.22D demonstrate the bond length change confirmed by Raman spectroscopy. FIG. 1.22A shows peaks for aromatic C—H out-of-plane deformation. FIG. 1.228 shows peaks for C—C stretching. FIG. 1.22C shows peaks for C—C or C—O stretching. FIG. 1.22D shows C—O stretching and phenolic C₄—O₂ stretching (1227.7 cm⁻¹); C—O—C stretching of the epoxy group (1250.6 to 1249.8 cm⁻¹); and C—O stretching (ether groups) and C—C stretching (1297.9 to 1297.1 cm⁻¹).

FIG. 1.23 shows the change of bond length confirmed by Near Edge X-ray Absorption Fine Structure Spectroscopy.

FIGS. 1.24A-1.24B show the relationship between force constant of anharmonic oscillation. FIG. 1.24A illustrates the full range of interatomic distance and FIG. 1.24B shows the small range around x₀. In a small variation around x₀, k decreases monotonically.

FIG. 1.25 shows the stress-strain curve for the programmed sample with 45% pre-strain. The sample was deformed within a very small strain.

FIG. 1.26 shows the structure of a repeating unit of the EPON-IPD network.

FIG. 1.27 shows the ideal and the chosen monomer (diamine) to prove the resource of the steric effect.

FIG. 1.28 provides DSC data for the un-programmed EPON-BACH thermoset network including the first and the second heating cycle.

FIG. 1.29A shows programming stress with strain; FIG. 1.29B shows the recovery stress evolution with time for the EPON-BACH thermoset polymer.

FIG. 1.30 provides DSC data for the 45% programmed EPON-BACH thermoset network including the first and the second heating cycles.

FIGS. 1.31A-1.31C illustrate the origin of “multiple energy well” model. FIG. 1.31A shows the relationship between potential energy and rotational angle for butane. FIG. 1.31B shows the two different cases for the energy barrier curve of paraffin based on Taylor's equation (22). FIG. 1.31C shows the “multiple energy well” model.

FIG. 1.32 provides a comparison of the exothermic reaction and free shape recovery.

FIGS. 1.33A-1.33B illustrate the interpretation of plastic deformation by “multiple energy well” model. FIG. 1.33A shows formation of energy gap during the programming. FIG. 1.33B shows that plastic deformation prevents the shape recovering by an energy gap.

FIG. 2.1 is a schematic demonstrating an example of curved rebar fabrication and the working principle thereof.

FIG. 2.2 is an example of curved SMP rebar after curing.

FIG. 2.3 is an example of a mold used for programming and recovering with the rebar in it (top: side view; bottom: top view).

FIGS. 2.4A-2.4B are example photographs of programming and recovering process of the curved rebar in the oven.

FIG. 2.5 graphs the evolution of the recovery force generated by the programmed SMP rebar at 160° C.

FIGS. 2.6A-2.6B are examples of tension programmed SMP rebar preparation.

FIGS. 3.1A and 3.1B show milled samples: (FIG. 3.1A) particles filtered by 1 mm sieve and (FIG. 3.1B) powder filtered by 150 μm sieve.

FIG. 3.2 shows samples used for the confirmation of the expansion of milled SMP powder. Sample 1 is the pure EPON-IPD without SMP powders. Sample 2 contains 1.5 g of compression programmed SMP powders and sample 3 contains 3 g of compression programmed SMP powders.

The drawings illustrate only example embodiments and are therefore not to be considered limiting of the scope described herein, as other equally effective embodiments are within the scope and spirit of this disclosure. The elements and features shown in the drawings are not necessarily drawn to scale, emphasis instead being placed upon clearly illustrating the principles of the embodiments. Additionally, certain dimensions may be exaggerated to help visually convey certain principles. In the drawings, similar reference numerals between figures designate like or corresponding, but not necessarily the same, elements.

### DETAILED DESCRIPTION

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of chemistry, material science, and the like, which are within the skill of the art.

The following examples are put forth so as to provide those of ordinary skill in the art with a complete disclosure and description of how to perform the methods and use the materials disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is at or near atmospheric. Standard temperature and pressure are defined as 20° C. and 1 atmosphere.

Before the embodiments of the present disclosure are described in detail, it is to be understood that, unless otherwise indicated, the present disclosure is not limited to particular materials, reagents, reaction materials, manufacturing processes, dimensions, frequency ranges, applications, specific temperature window or the like, as such can vary. It is also to be understood that the terminology used herein is for purposes of describing particular embodiments only, and is not intended to be limiting. It is also possible in the present disclosure that steps can be executed in different sequence where this is logically possible.

It must be noted that, as used in the specification and the appended claims, the singular forms “a,” “an,” and “the” include plural referents unless the context clearly dictates otherwise.

### Definitions

Stress, as used herein, is defined as load per unit area.

Strain, as used herein, is defined as change in length per unit length. During mechanical testing, stress and strain appear in pairs at any given instant, and a collection of the pairs forms the stress versus strain curve.

General Discussion

In general, embodiments of the present disclosure provide for methods of making, compositions including shape memory polymers and thermoset polymer networks, and products including shape memory polymers and thermoset polymer networks. The products and compositions provided for may be used in structures or devices benefitting from shape and stress recovery, e.g. actuators, self-healing materials, sealants, proppants, expandable aggregates, morphing structures, stents, sutures, soft robots, smart textiles, construction materials, and other applications needing mechanical resources.

The present disclosure includes a shape memory polymer (SMP). Advantageously, the stress memory and energy storage and output capabilities are higher than existing shape memory polymers and thermoset polymer networks. The enhancement of stress memory is achieved by enriching energy storage during programming. Based on the basic thermodynamics, ΔG=ΔH−TΔS, where ΔG, ΔH and ΔS are the change of Gibbs free energy, enthalpy and entropy, respectively, and T is the absolute temperature; hence, the stored energy includes both entropy and enthalpy. Obviously, stress recovery and energy output depend on the energy input during programming and the energy storage in the temporary shape after programming. Because entropy elasticity is the acknowledged driving force for shape and stress memory in previous SMPs, storing enthalpy during programming of the shape memory polymers and thermoset polymer networks of the present disclosure is a way to further increase the recovery stress and energy output.

Embodiments of the present disclosure include a shape memory polymer as above, where the stress memory and energy storage capabilities are higher than existing shape memory polymers and thermoset polymer networks. In embodiments, the shape memory polymer can have a recovery stress of about 15 to about 20 MPa or about 16.5 to about 18.5 MPa, an energy output of about 2.0 to about 2.5 MJ/m³ or about 2.1 to 2.4 MJ/m³, and/or an energy output efficiency of about 50% or greater, about 60% or greater, about 70% or more, or about 80% or more.

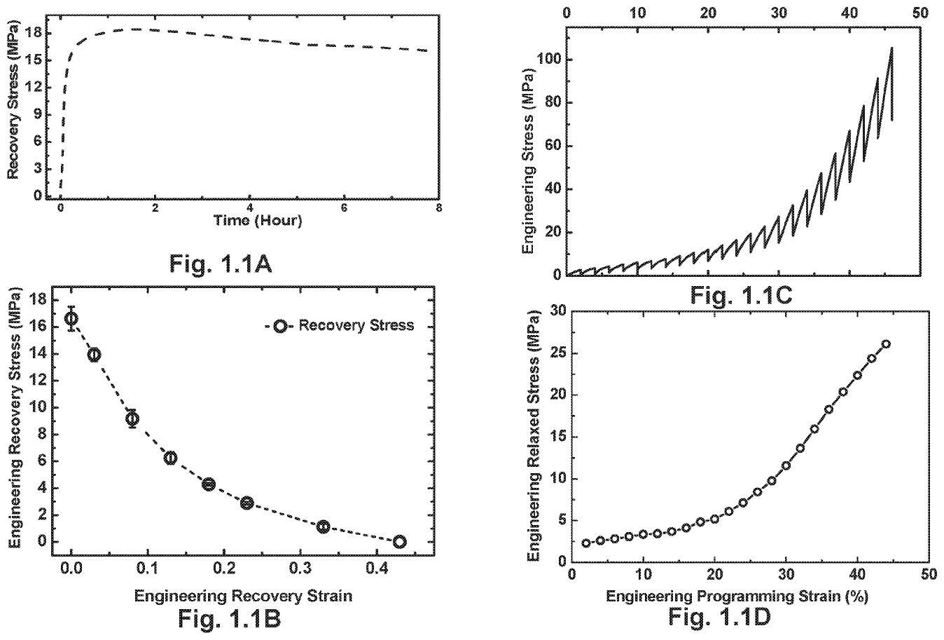

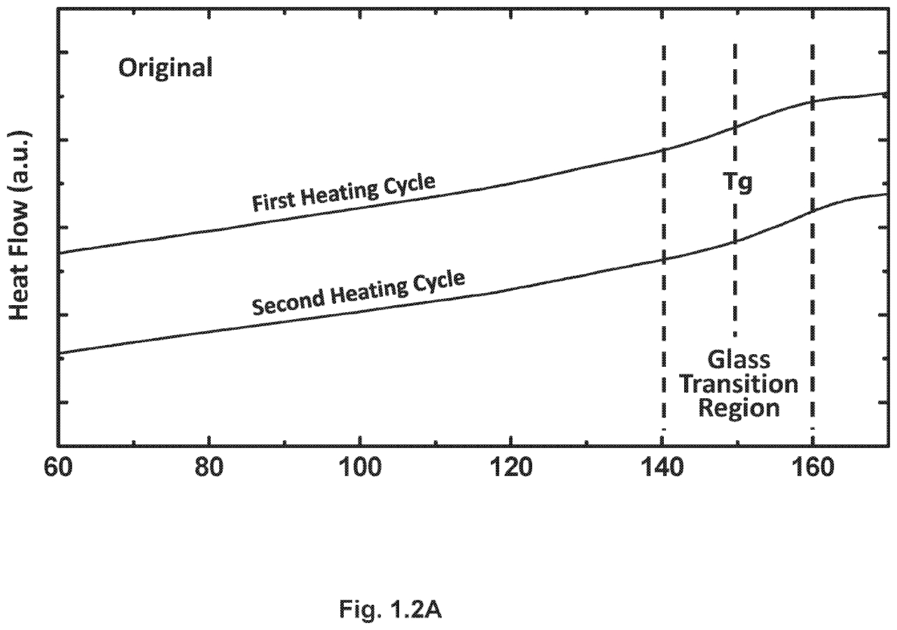

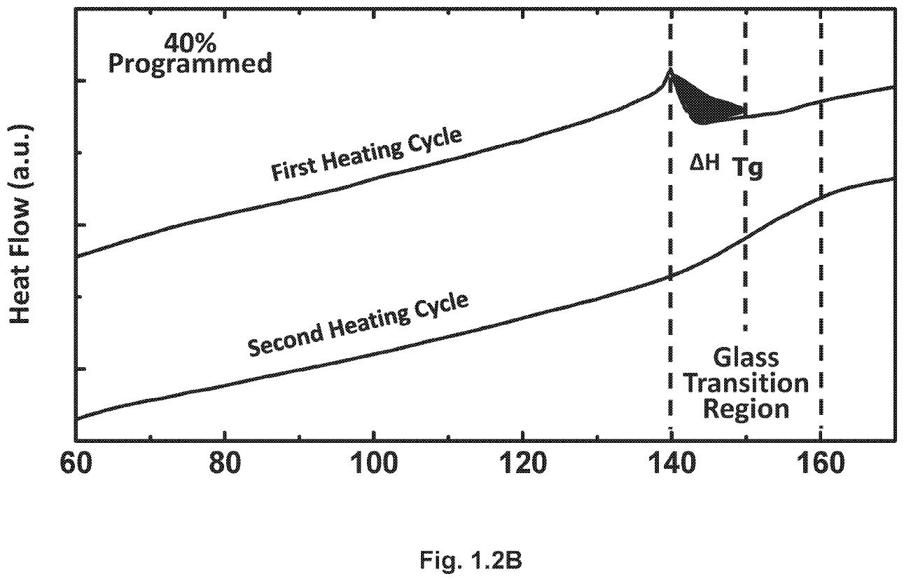

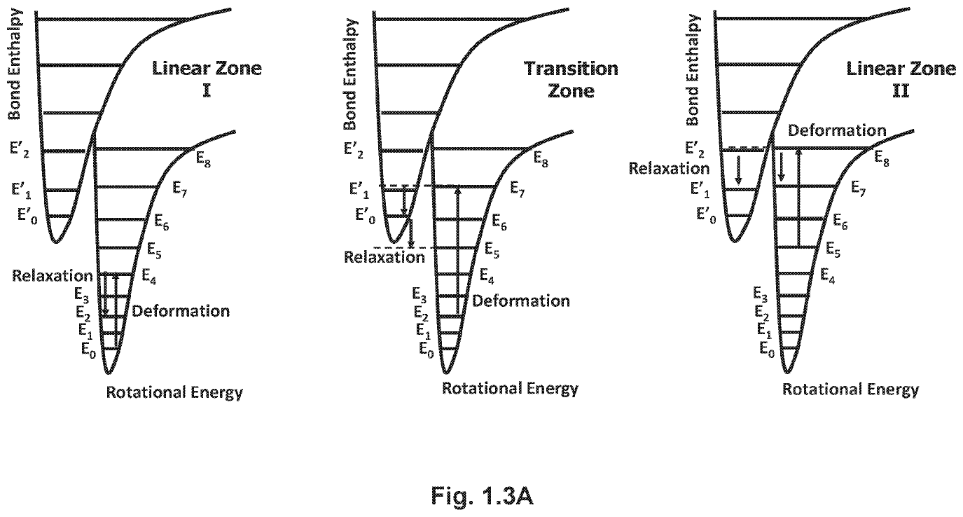

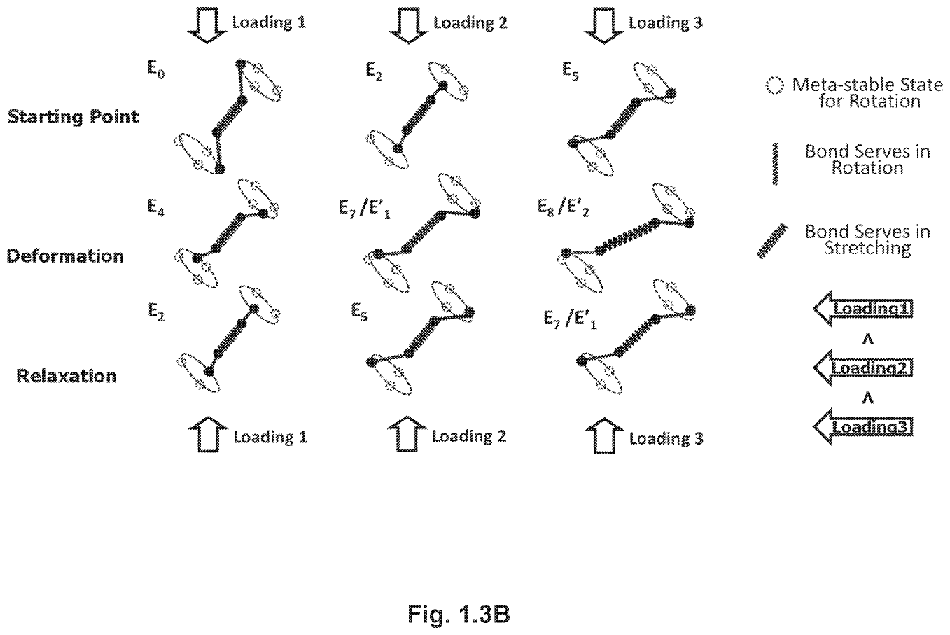

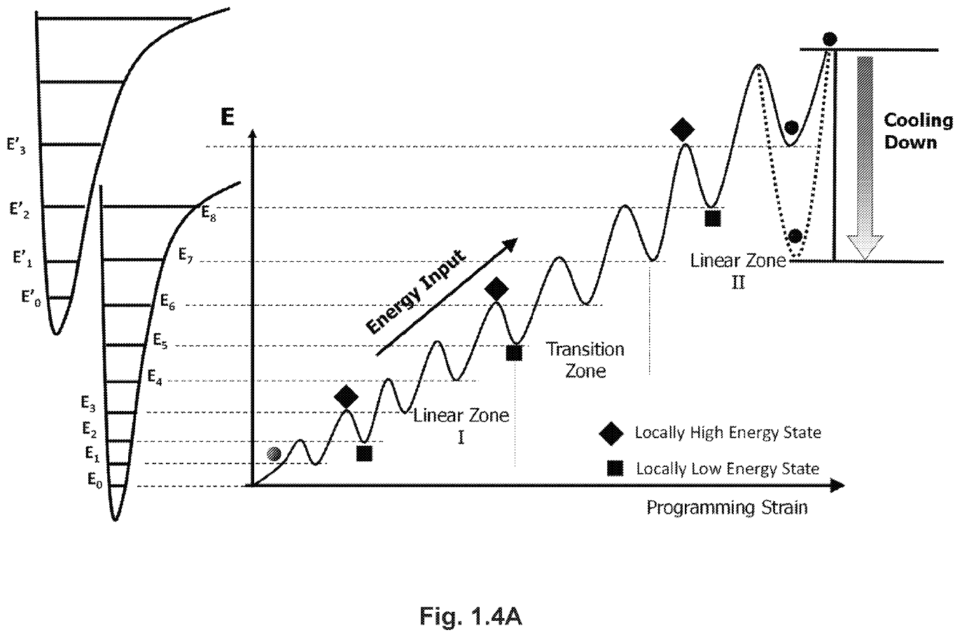

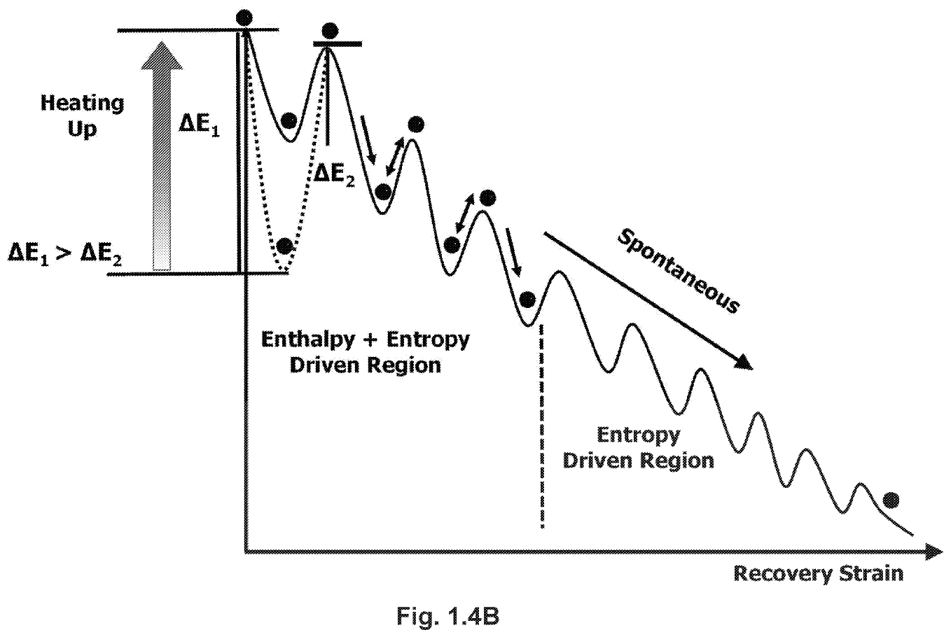

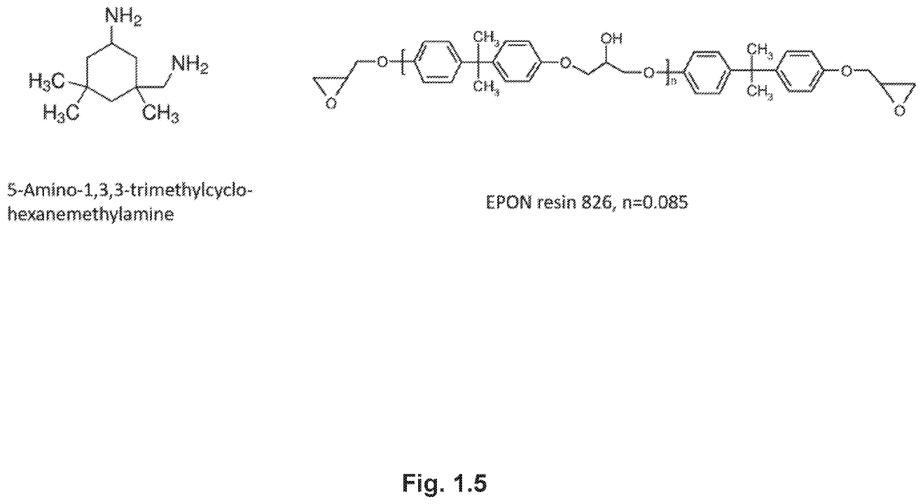

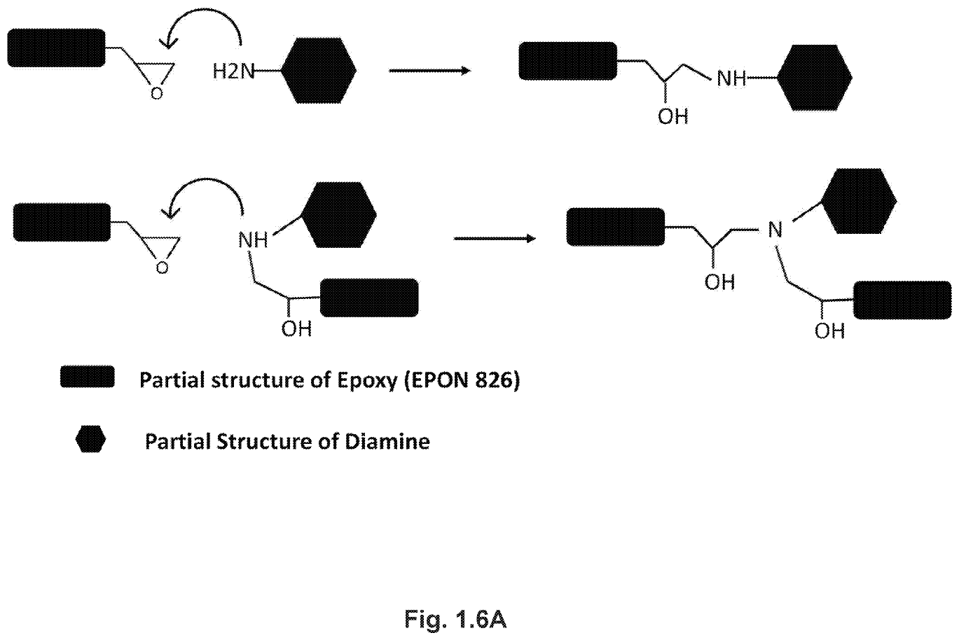

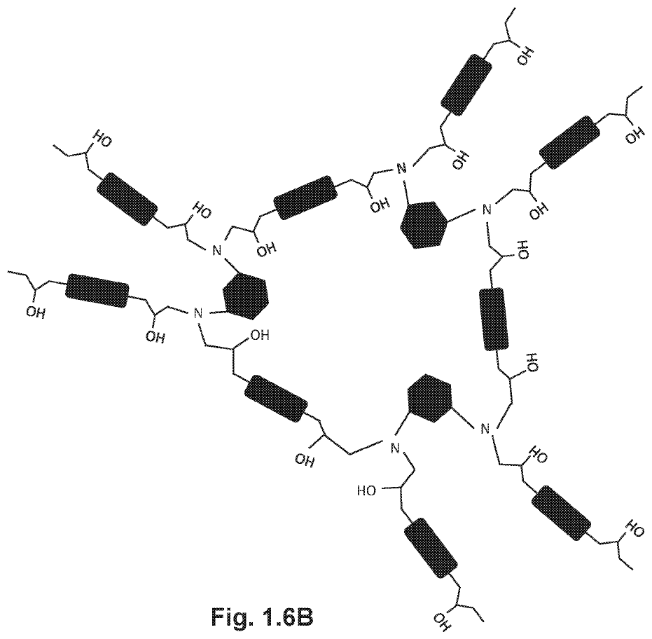

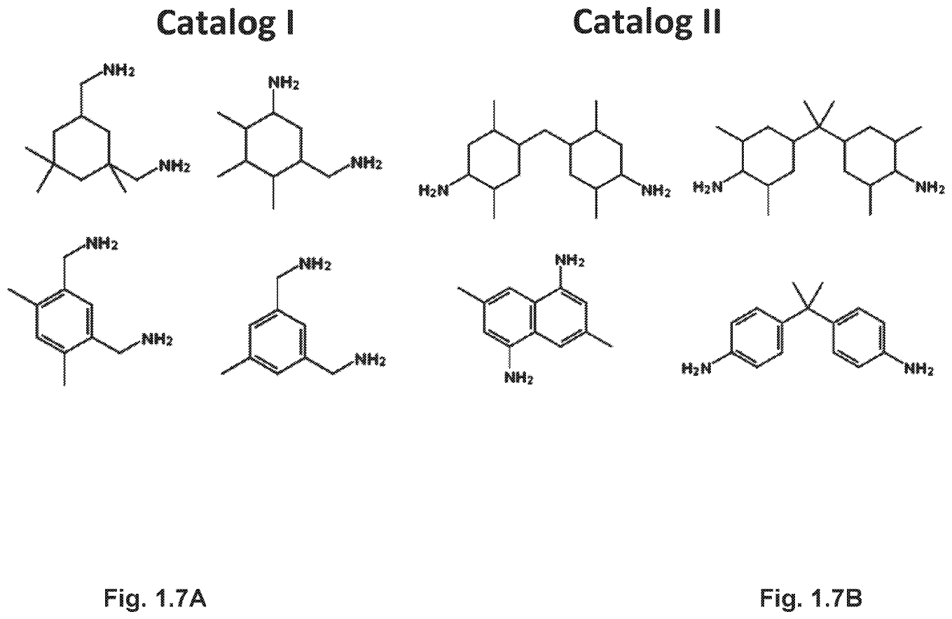

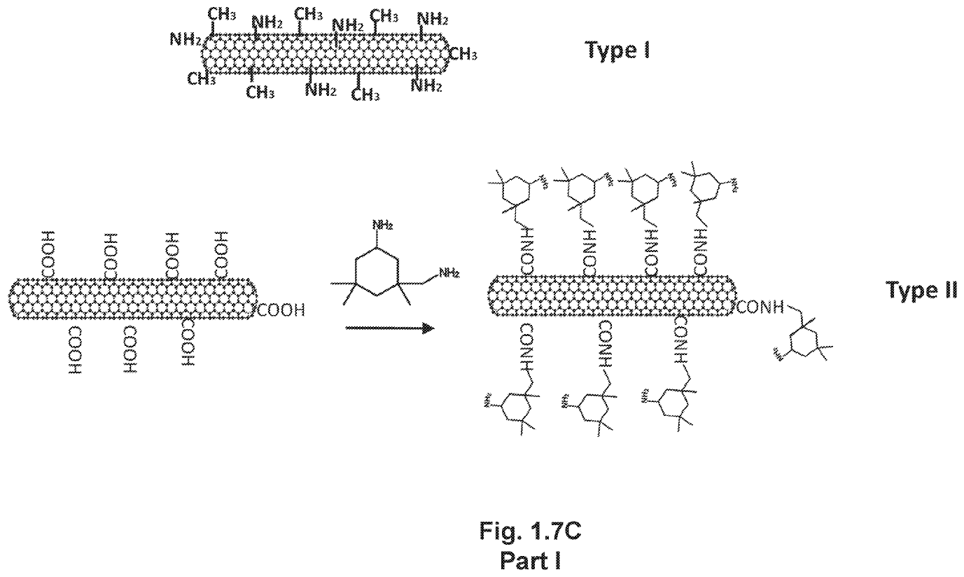

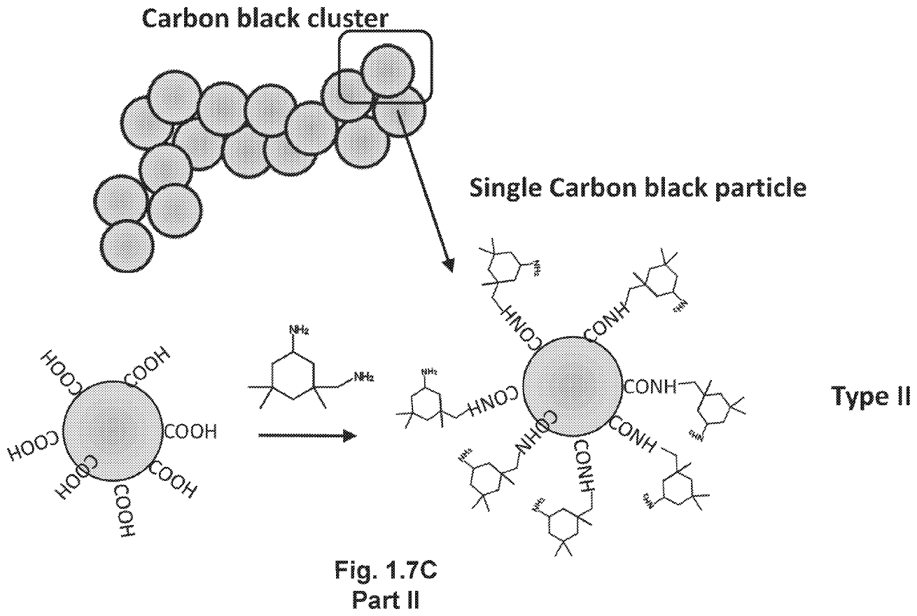

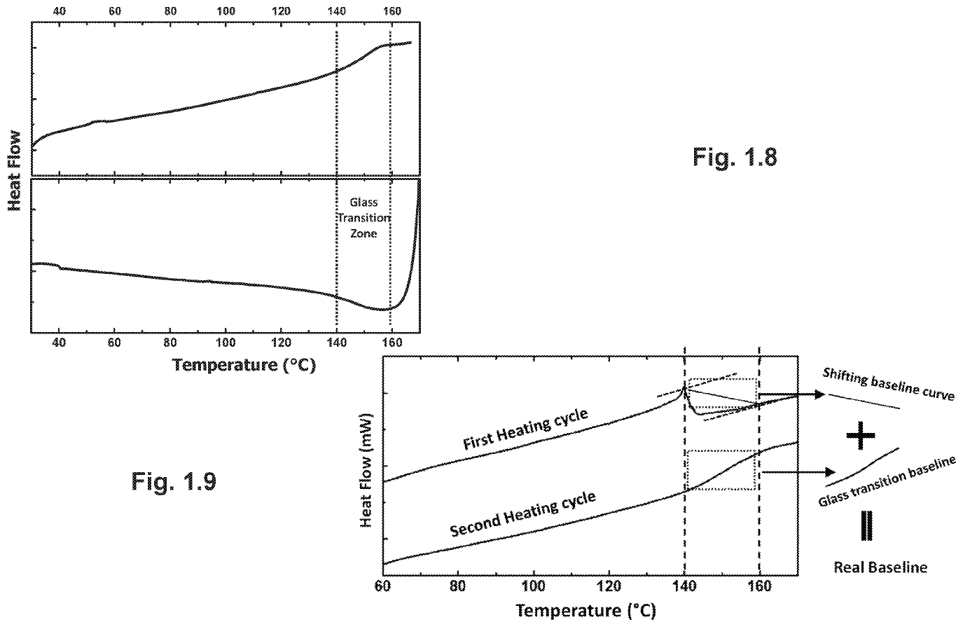

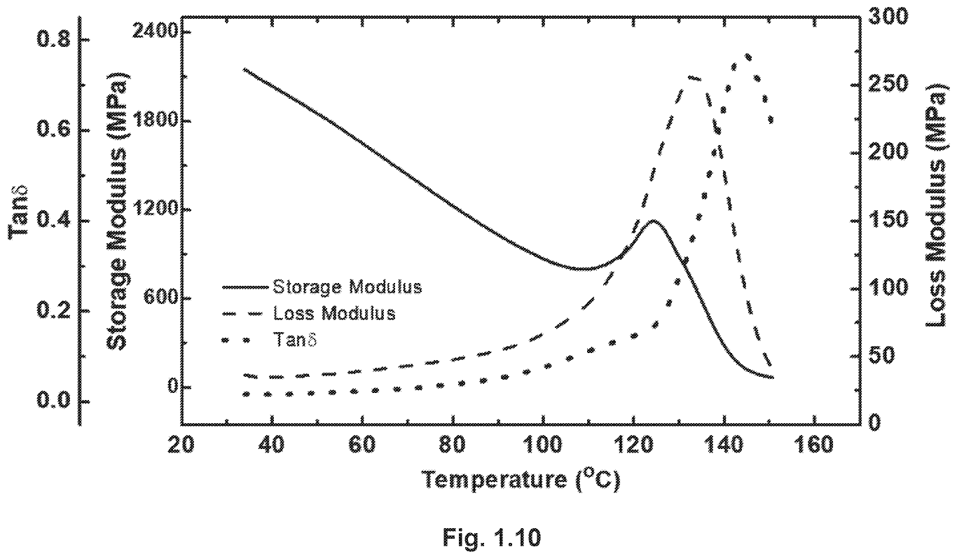

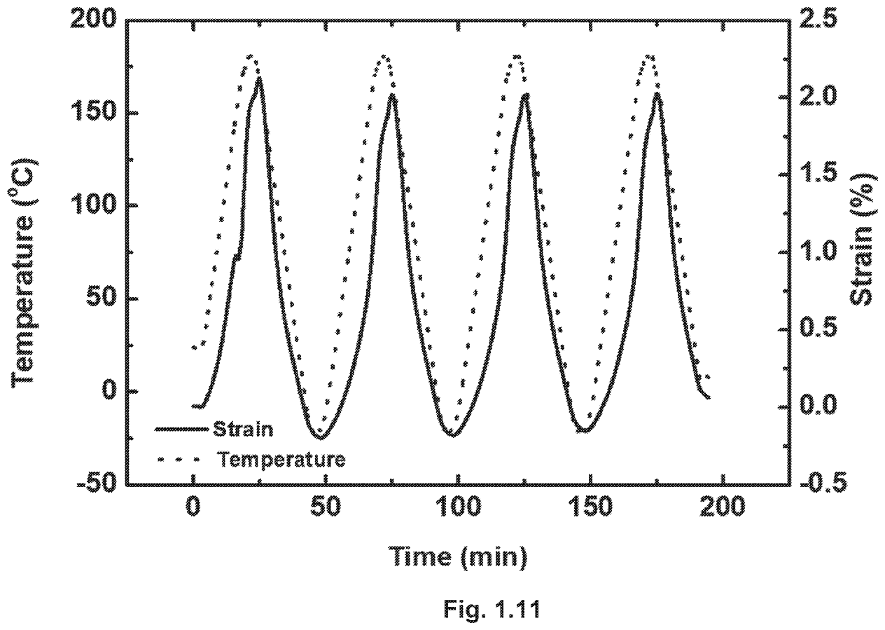

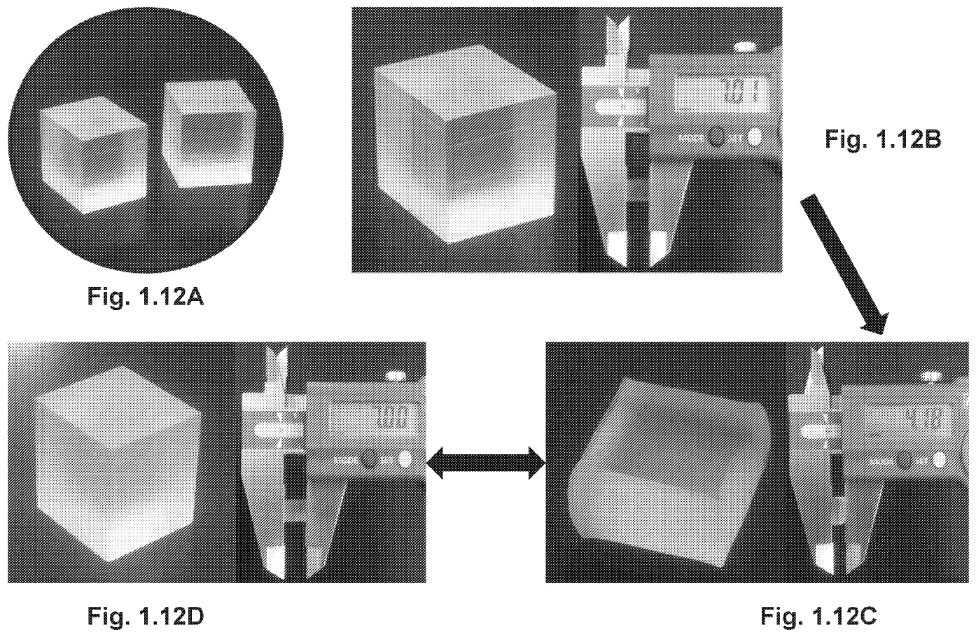

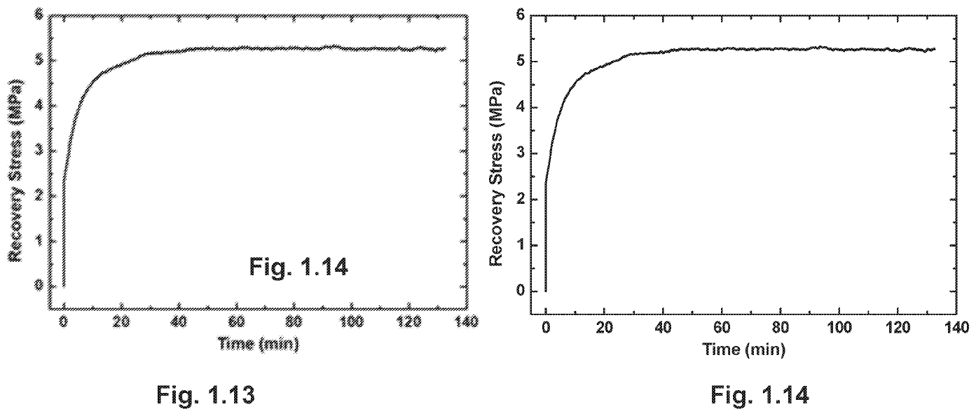

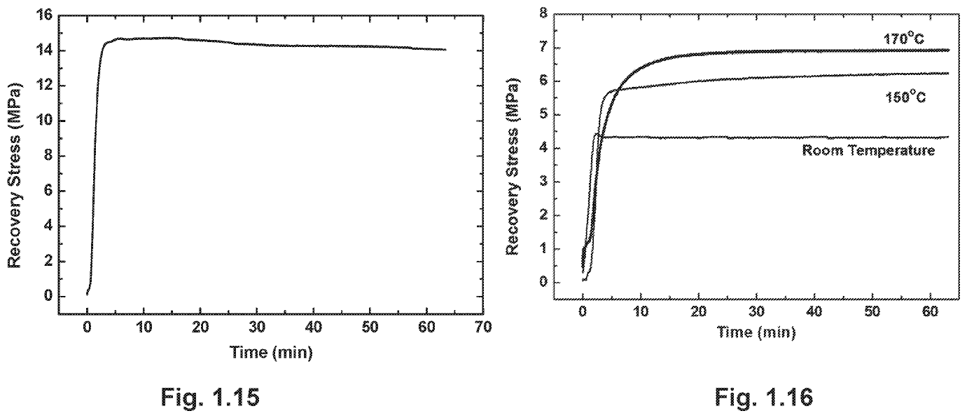

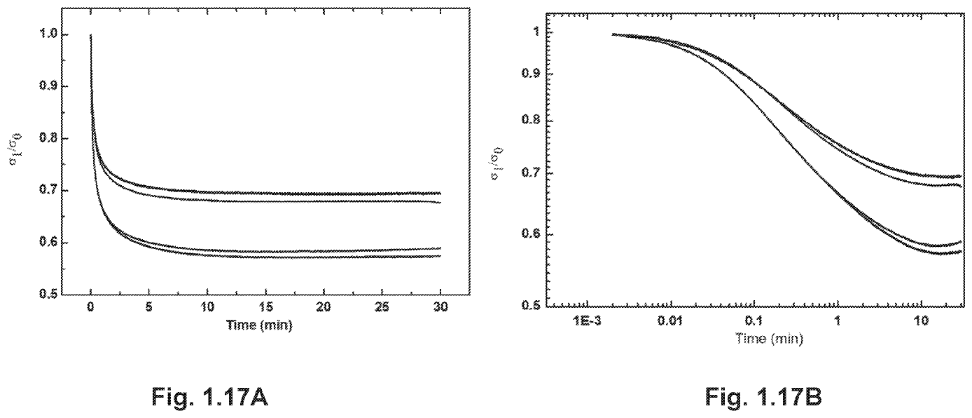

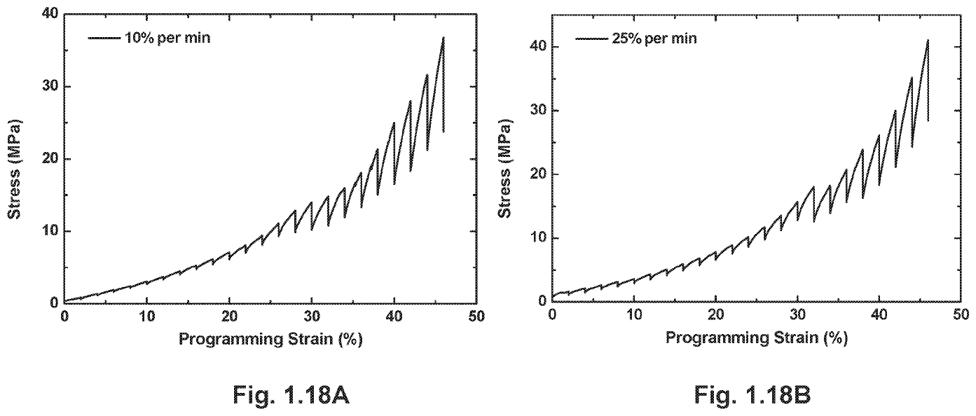

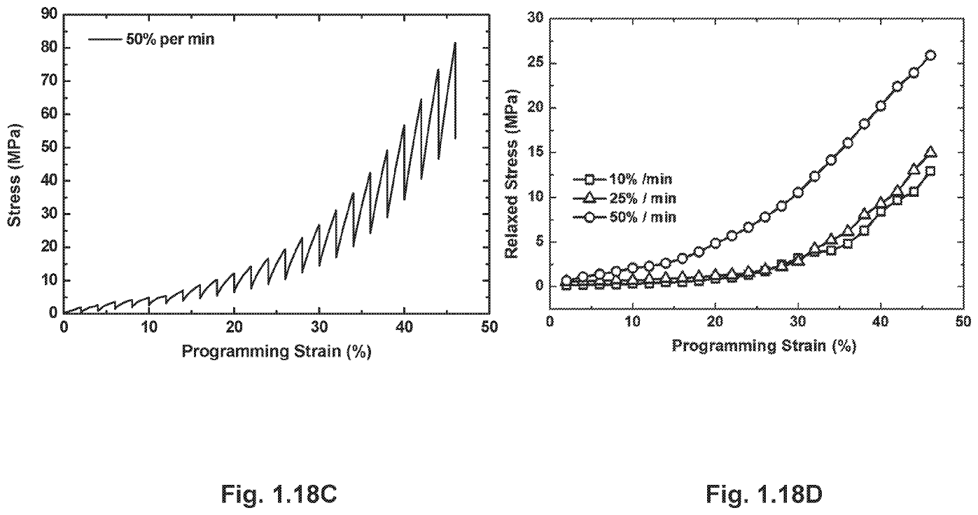

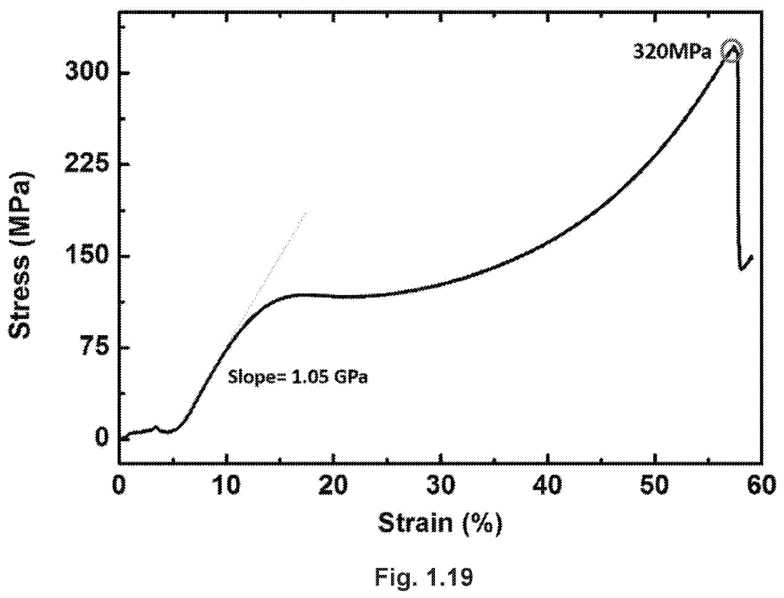

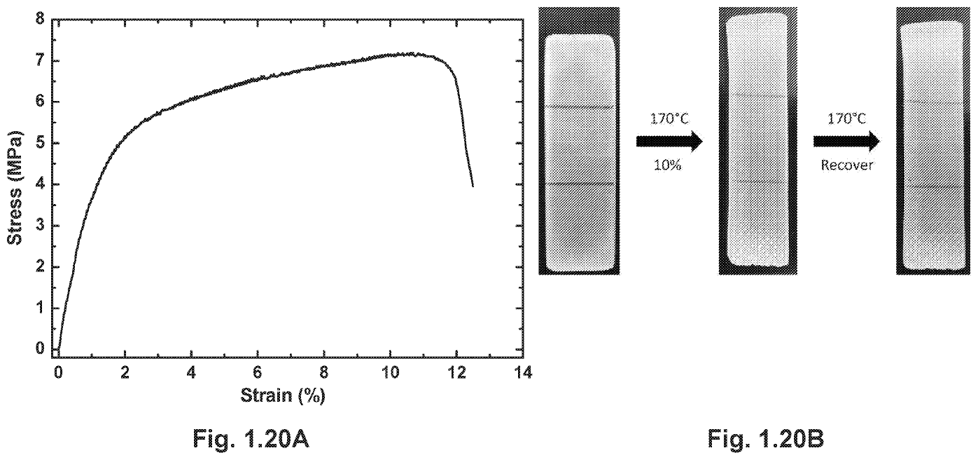

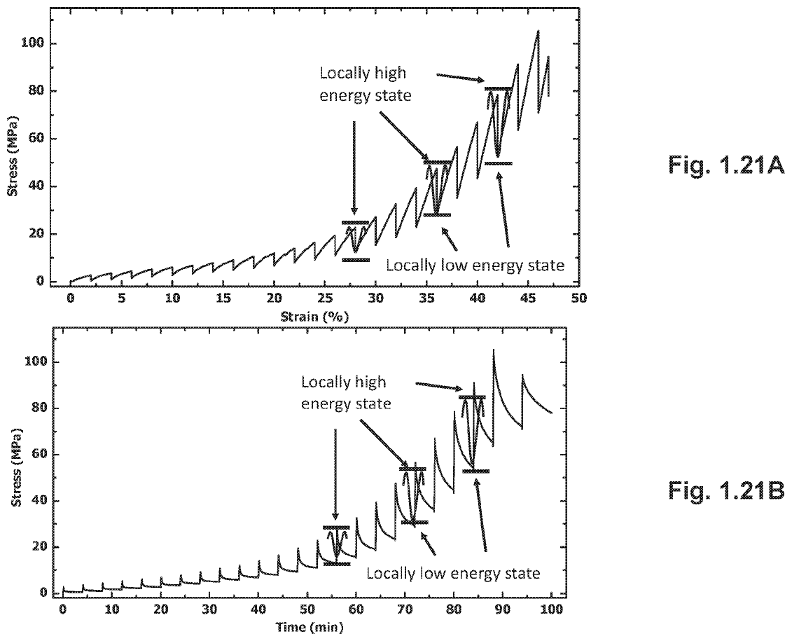

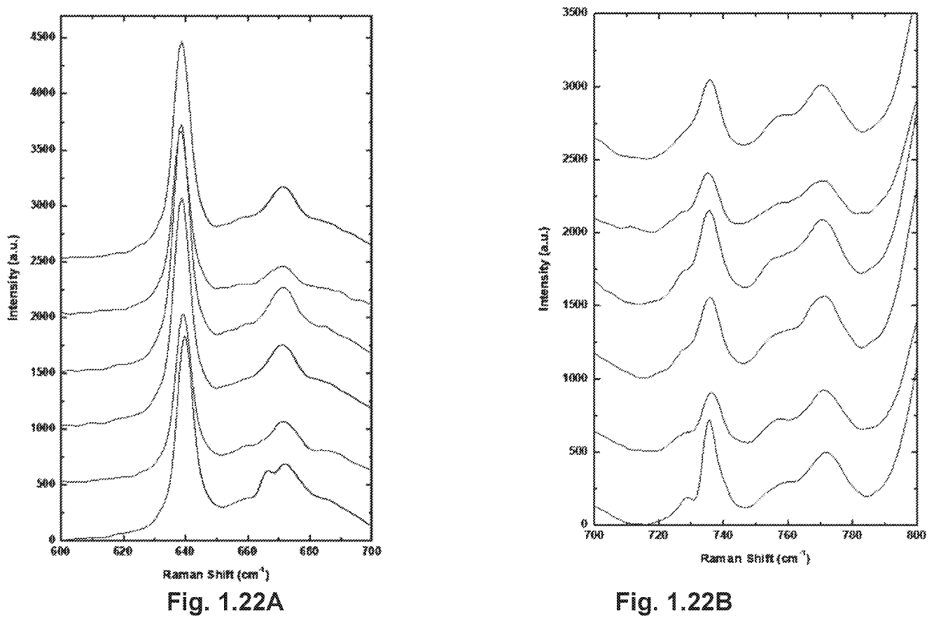

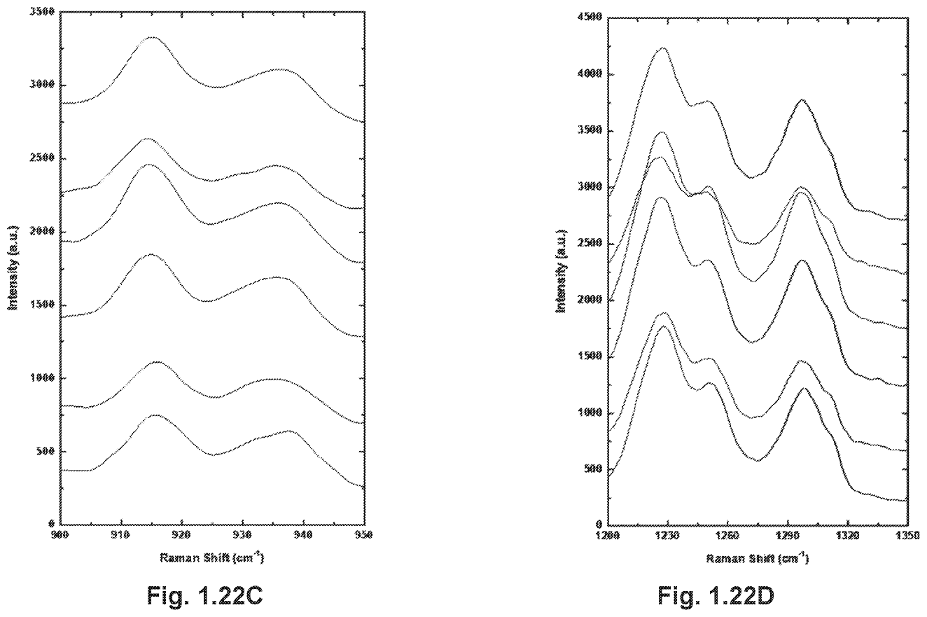

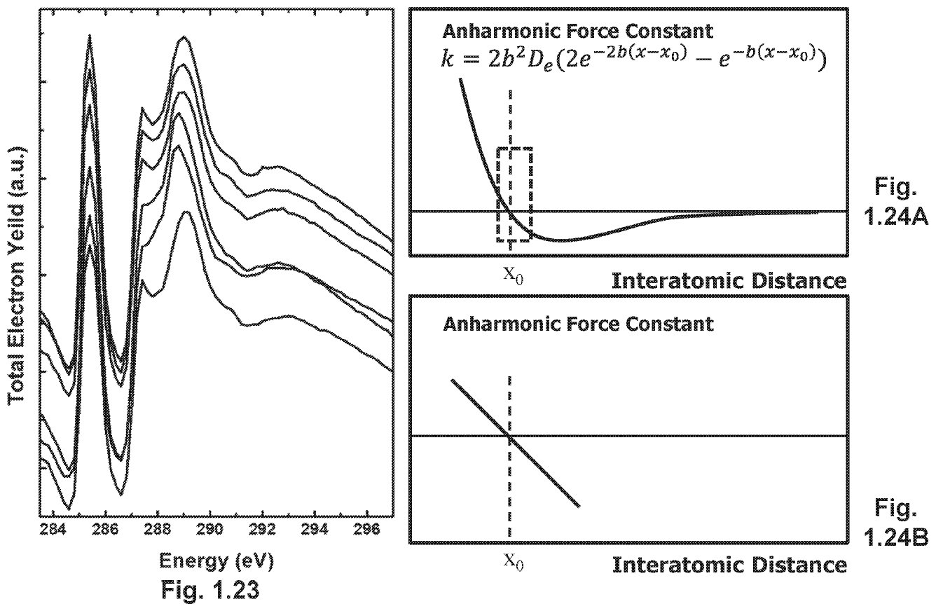

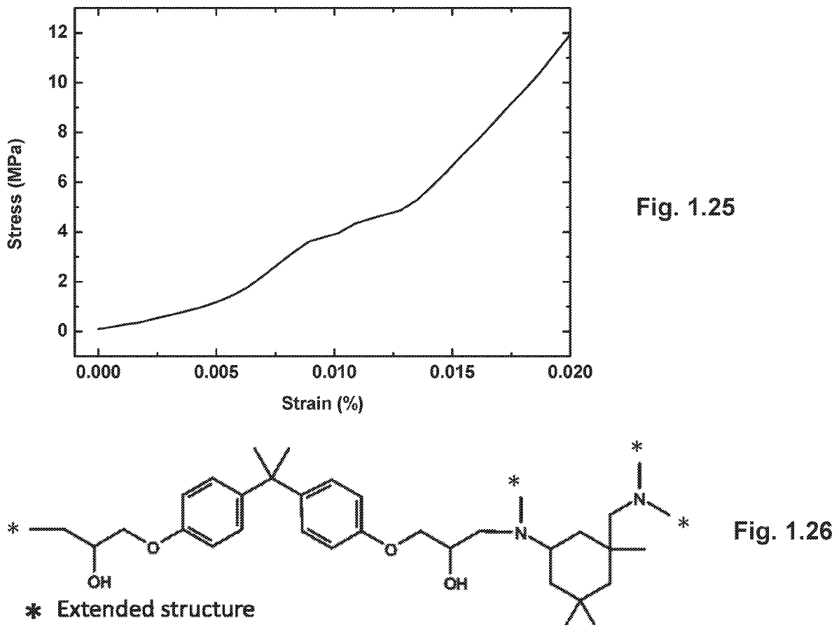

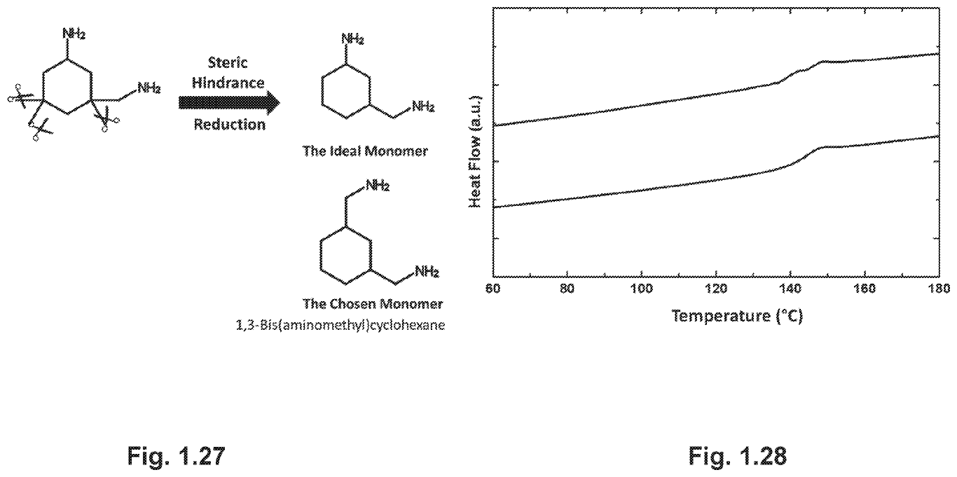

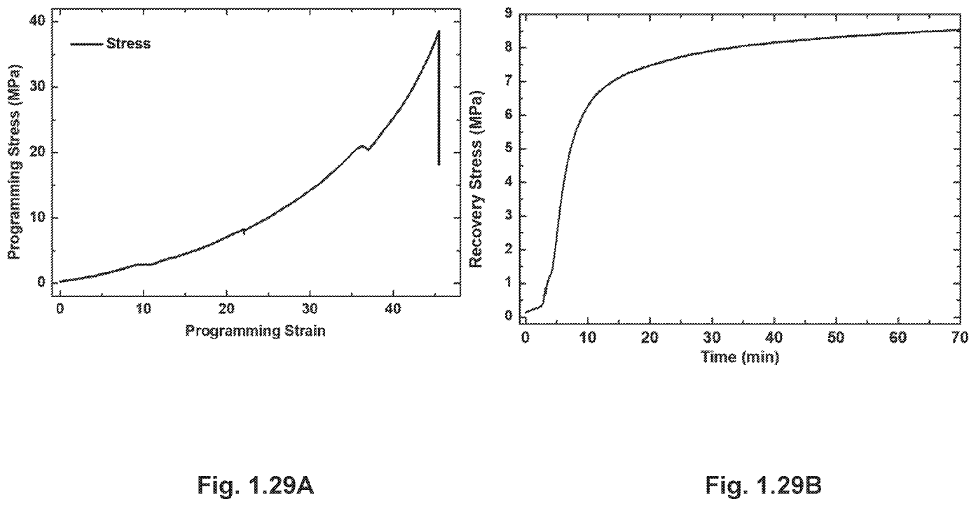

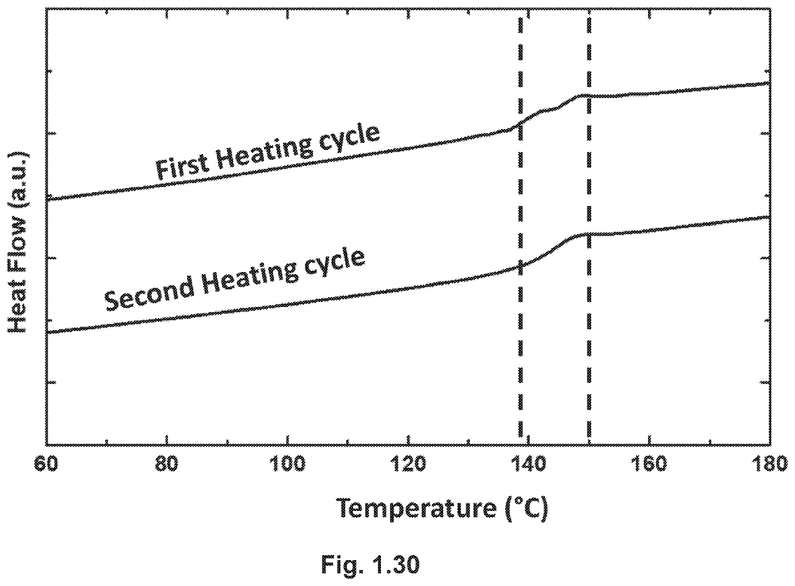

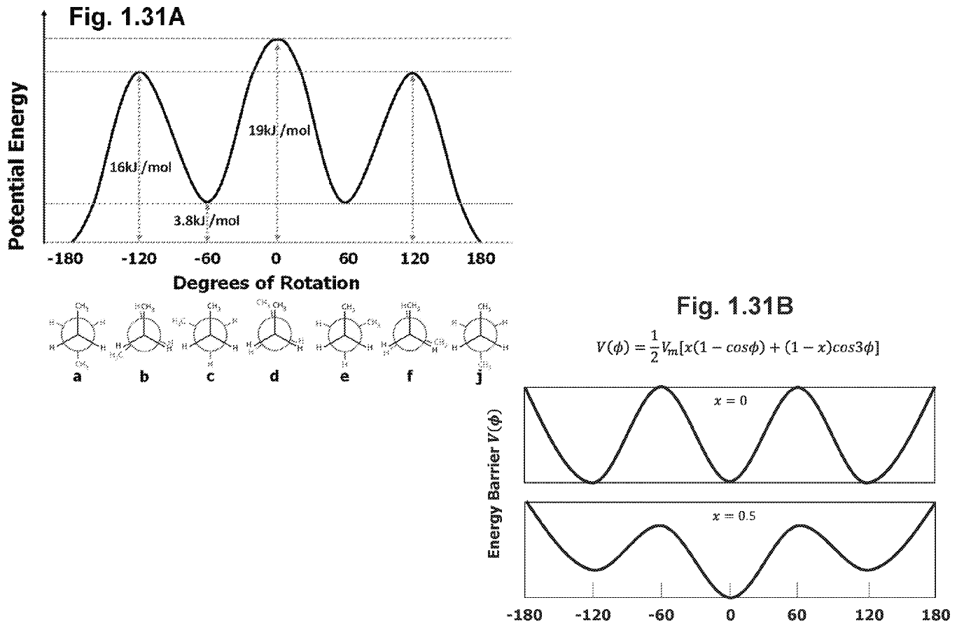

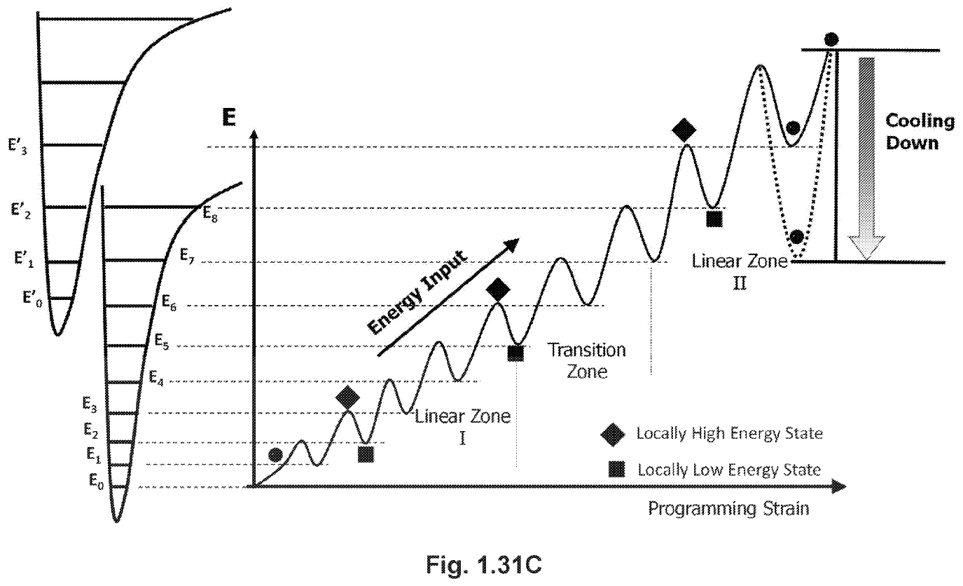

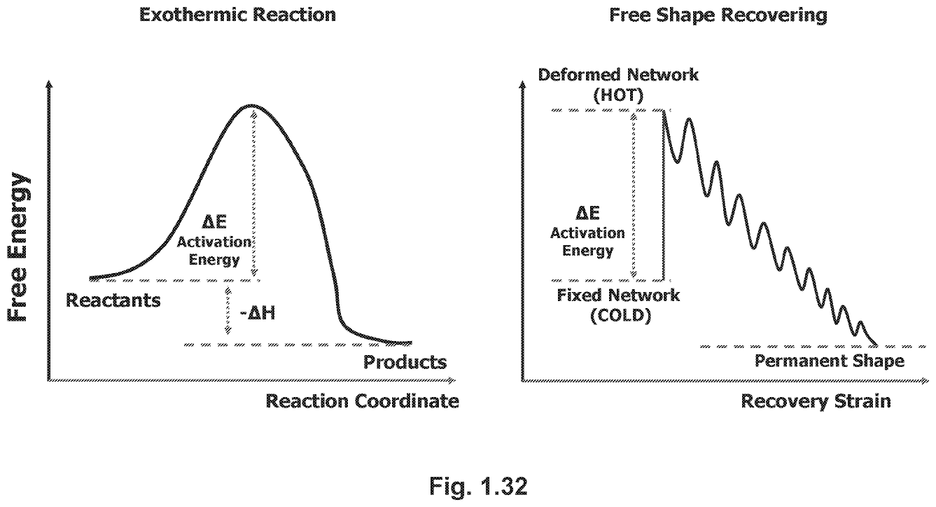

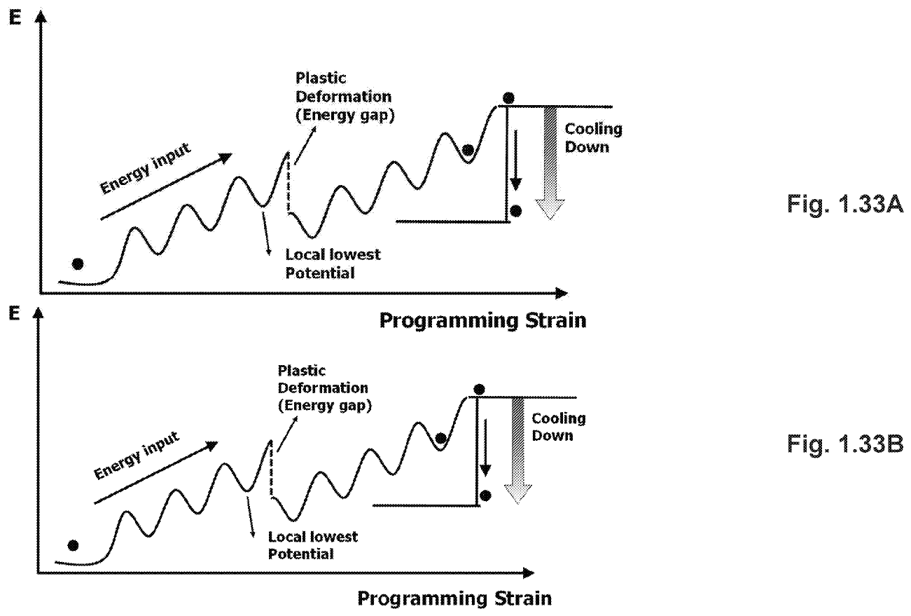

The present disclosure provides for thermoset polymer networks including products made by reacting an epoxy and an amine (one example of the reacted product is referred to as “EPON-IPD”). In embodiments, the amine (also referred to as “precursor amine”) can be 5-Amino-1,3,3-trimethylcyclohexanemethylamine, 1,5,5-trimethyl-1,3-Cyclohexanedimethanamine, 3-amino-4-5-6-trimethyl-Cyclohexanemethanamine, 4,6-dimethyl-1,3-Benzenedimethanamine, 5-methyl-1,3-Benzenedimethanamine, 4,4′-methylenebis[2,5-dimethyl-Cyclohexanamine], 4,4′-(1-methylethylidene) bis[2,6-dimethyl-Cyclohexanamine], 3,7-dimethyl-1,5-Naphthalenediamine, Diaminonaphthalene, Diaminophenanthrene,4,4′-(1-methylethylidene) bis-Benzenamine, 2,5-Diaminotoluene, 4,4-Methylenebis(2-methylcyclohexylamine, 4,4-Methylenebis(cyclohexylamine), 4,4′-Methylenebis(2-methylcyclohexylamine), 1,8-Diamino-p-menthane, Diaminophenazine, o-Phenylenediamine, p-Phenylenediamine, m-Phenylenediamine, N-Phenyl-o-phenylenediamine, N-Phenyl-benzene-1,3-diamine, N-Phenyl-p-phenylenediamine, N,N-Diphenyl-p-phenylenediamine, or 1,2,4,5-Benzenetetramine (see Table 1.1 and FIGS. 1.7A-1.7B). In various embodiments, the epoxy (also referred to as “precursor epoxy”) can be a bisphenol A-based epoxy resin, for example bisphenol A diglycidyl ether (EPON 826, DuPont™). In an embodiment, the ratio of the amount of the epoxy to the amine should keep stoichiometry. Additional details regarding exemplary structures are provided in the Example. In a particular embodiment, the amine can be 5-Amino-1,3,3-trimethylcyclohexanemethylamine (Structure I, see Examples) and the epoxy can be EPON 826 (Structure II wherein n=0.085, see Examples). In embodiments, n in Structure II can be a positive real number such as 1 to 10,000 or 1 to 1000, or 1 to 100.

Thermoset polymer networks including an epoxy moiety and an amine moiety are also provided for, where the precursor epoxy and precursor amine are as described above. The above described thermoset polymer networks can be made by mixing an aforementioned epoxy moiety and amine moiety, then curing the mixture under heat of about 100 to 200° C. or about 150° C. Additional details are provided in the Examples.

A shape memory polymer including thermoset polymer networks as above, as described herein, has a starting state, a programmed state, and an activated (also referred to as “shape recovery”, “recovered”, or “rubbery”) state. In the starting state, the shape memory polymer has a starting volume. In the programmed state, the shape memory polymer has a programmed state volume. In the activated state, the shape memory polymer has an activated state volume. In an embodiment, the starting state has a volume greater than the programmed state (and the corresponding volumes), while the programmed state has a volume that is less than that of the activated state (and the corresponding volumes). In an embodiment, the shape memory polymer can be a block specimen that in the starting state is about 5 to 50% longer than the shape memory polymer specimen in the programmed state as a result of unidirectional compression loading during programming. In an embodiment, the shape memory polymer block specimen in the activated state is about 5 to 50% longer than the shape memory polymer specimen in the programmed state as a result of unidirectional expansion opposite to the direction of the programming compression load. In an embodiment, the amount of expansion of the shape memory polymer can be tailored for each specific application.

The shape memory polymer in the programmed state will convert to the shape memory polymer in the activated state when an activation condition is applied to the shape memory polymer in the programmed state. In particular, when the thermoset polymer network is subject to an activation temperature and uniaxial compression strain in the range of 5%-50%, the shape memory polymer will change states from the programmed state to the activated state. In an embodiment, the activation condition can be an activation temperature, a moisture, a light, a pH, a magnetic field, an ultrasonic wave, electricity current, and a combination thereof. In an embodiment, the activation condition can be an activation temperature. In an embodiment, the activation temperature can be tailored for each specific application. In an embodiment, the activation temperature can be about 10° C. to 180° C., about 10° C. to 120° C., or about 70° C. to 180° C., and is within or above the transition temperature of the polymer. The shape memory polymer in the programmed state can be exposed to the activation conditions in-situ such as when mixed with another material or in use (e.g. when embedded in concrete or as proppant, or as a sealant. Alternatively, the SMP can be compression programmed prior to combining with other materials, and as a result the volume of the shape memory polymer increases the volume of the combined materials upon activation.

The present disclosure also provides for shape memory polymers including the thermoset polymer networks described above. In embodiments, the epoxy can be grafted onto a surface of carbon black, carbon nanotubes, or other nanoparticles. During the programming process, the shape memory polymers of the present disclosure store energy through an enthalpy increase provided by stretched bonds. The stress relaxation in the rubbery state (Also referred to as the “rubbery” state) is also reduced, thereby increasing the energy output during shape recovery.

In various embodiments, the shape memory polymer has the characteristic of having energy stored through an enthalpy increase. The enthalpy increase is the result of stretched bonds during programming of the shape memory polymer (where the shape memory polymer has a recovery stress of about 15 to about 20 MPa, and where the shape memory polymer has an energy output of about 2.0 to about 2.5 MJ/m³, and/or the energy output efficiency is 50% or greater.)

Embodiments of the present disclosure include methods of making a thermoset polymer network described above. The thermoset polymer network is formed by mixing an epoxy and a diamine, and curing the mixture

The present disclosure also provides for articles having shape memory. The article can include a thermoset polymer network as described above. The article can have a recovery stress of about 5 MPa to 20 MPa, about 10 MPa to 20 MPa, or about 15 MPa to 20 MPa. The article can also include fillers (e.g. fibers, particles, ribbons, nanoparticles, glass fibers, carbon fibers, polymeric fibers, ceramic fibers, metallic fibers, ceramic particles, metallic particles, polymeric particles, carbon nanotubes, nanoclays, carbon blacks, graphene). The volume fraction of the filler in the article can be from about 0% to 80%, or from about 50% to 70%.

Methods for making such articles can include mixing an epoxy and a diamine (as above), forming the mixture into a shape, and curing the mixture. Further steps can include programming the article. Programming can occur as described above in reference to SMPs (e.g. placing the article under compression and heating).

The terms “fiber” or “fibers” as used herein refers to materials that are in the form of discrete elongated pieces. The fibers may be produced by conventional techniques such as electrospinning, interfacial polymerization, pulling, and the like. The fiber can be in the form of bundles or strands of fibers (e.g., yarn), rovings, woven fibers, non-woven fibers, three-dimensional reinforcements such as braids, and the like. Fiber can also include organic fibers or natural fibers (e.g., silk). The organic fiber can be formed from organic polymers capable of forming fibers such as poly(ether ketone), polyimide, polybenzoxazole, poly(phenylene sulfide), polyesters, polyethylene, aromatic polyamides (e.g., an aramid polymer such as para-aramid fibers and meta-aramid fibers), aromatic polyimides, polybenzimidazoles, polyetherimides, polytetrafluoroethylene, acrylic resins, poly(vinyl alcohol) or the like; natural fibers (e.g., silk). In an aspect, the fiber can be a carbon fiber such as Tarifyl® produced by Formosa Plastics Corp, (e.g., 12 k, 24 k, and 48 k tow, specifically fiber types TC-35 and TC-35R), carbon fiber produced by SGL Group (e.g., 50 k tow), carbon fiber produced by Hyosung, carbon fiber produced by Toho Tenax, fiberglass produced by Jushi Group Co., LTD (e.g., E6, 318, silane-based sizing, filament diameters 14, 15, 17, 21, and 24 μm), and polyester fibers produced by Amann Group (e.g., Serafile 200/2 non-lubricated polyester filament and Serafile COMPHIL 200/2 lubricated polyester filament), or other glass fibers (E-glass, S-glass).

In one particular embodiment, the article can be shape memory polymer rebar including glass fibers or carbon fibers. Advantageously, the articles can be used to reinforce products or materials that crack under strain (e.g. SMP-based rebar to reinforce concrete) and the articles will not corrode like current materials such as steel can.

The present disclosure also provides for methods of making a shape memory composite consistent with the description above. In an embodiment the method includes compressing a thermoset polymer network (as above) at a temperature of about 140° C. to 170° C. to form a shape memory polymer in a programmed state. Then the shape memory polymer is cooled. Smaller particles of the shape memory polymer can be formed by breaking, crushing, milling, or other methods of forming small particles known in the art. The resulting small particles (e.g. a powder) can be added to a matrix to form a shape memory polymer composite, followed by curing the shape memory polymer composite. By adding small particles of SMP in a programmed state to another material (e.g. the matrix), the entire resulting composite can expand when exposed to an activation condition. In various embodiments, the programmed powders can be mixed into a matrix (e.g. a resin, a polymer, cement slurry) prior to curing to form a SMP composite material. Where the curing temperature is lower than the glass transition temperature of the SMP powders, expansion of the embedded SMP powders will not be triggered during curing. Upon exposing the composite to an activation condition (e.g. a temperature), the SMP particles will expand, resulting in an expansion of the entire composite material. The composite can expand about 5 to 50% from the pre-activation state.

### EXAMPLES

Now having described the embodiments of the disclosure, in general, the examples describe some additional embodiments. While embodiments of the present disclosure are described in connection with the example and the corresponding text and figures, there is no intent to limit embodiments of the disclosure to these descriptions. On the contrary, the intent is to cover all alternatives, modifications, and equivalent included within the spirit and scope of embodiments of the present disclosure.

### Example 1

Low output in stress and energy in rubbery state has been a bottleneck for wide-spread applications of thermoset shape memory polymers (SMPs). Traditionally, stress or energy storage in thermoset network is through entropy reduction by mechanical deformation or programming. The present disclosure describes a new mechanism for energy storage, which stores energy primarily through enthalpy increase by stretched bonds during programming. As compared to entropy driven counterparts, which usually have a stable recovery stress from tenths to several MPa and energy output of several tenths MJ/m³, the rubbery network of the present disclosure achieved a recovery stress of 17.0 MPa and energy output of 2.12 MJ/m³ in bulk form. The giant stress and energy release in the rubbery state will enhance applications of thermoset SMPs in engineering structures and devices.

To obtain a thermoset network with high recovery stress and energy output through enthalpy storage, a commercially available epoxy (EPON 826, Structure II) was reacted with a rigid diamine named isophorone diamine (IPD, Structure I), which can provide a large steric hindrance. Detailed synthesis procedure for the EPON-IPD network is described in the methods section(s) of the example. The large steric hindrance can ensure enthalpy increase during programming and also can reduce the stress relaxation in rubbery state (see FIGS. 1.17A-B), which enhances energy output during partially constrained shape recovery test.

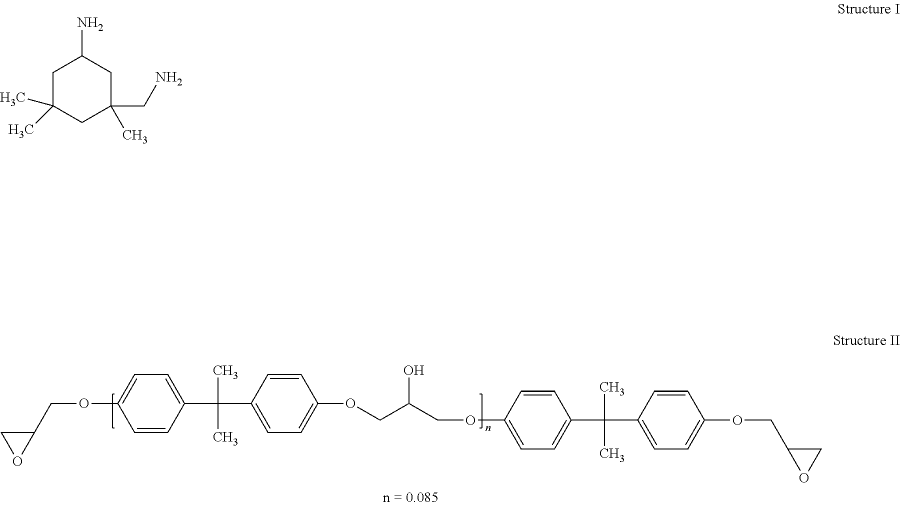

FIG. 1.1A shows the fully constrained stress recovery test results in rubbery state (recovered at 170° C. for 8 hours; the glass transition zone is between 140° C.-160° C.; see FIG. 1.8 for a sample compression programmed with 45% pre-strain at a strain rate of 0.5 mm/mm/min and temperature of 170° C.). Detailed compression programming and fully constrained shape recovery test can be found in Supplementary Information in sections 3.1 and 4.2, respectively. The recovery stress in the rubbery state is about 17.87 MPa at 1.0 hour, 17.0 MPa at 1.5 hours, and 16.07 MPa at 8 hours. The maximum recovery stress, as high as 17 MPa in rubbery state, was obtained and maintained. The recovery stress versus recovery strain through partially constrained shape recovery test is plotted in FIG. 1.1B. The test procedure is given in section 4.3 in the Supplementary Information. The free shape recovery ratio was 99.9%. The energy output, which is calculated based on the area of the recovery stress-strain curve, is about 2.12 MJ/m³. Based on FIG. 1.1B, more than 6 MPa stress can still be maintained even when the programmed sample with 45% pre-strain is allowed to recover 10% of strain. This stress is adequate to drive crack closure in real world applications (18). Based on this recovery stress—recovery strain curve, the energy output, i.e., the area included by the recovery stress—recovery strain curve, is calculated to be 2.12 MJ/m³, which is much higher than other thermoset SMPs or even elastically deformed metals, and is even comparable to some shape memory alloys (SMAs), as given in Table 1.3.

FIG. 1.1C shows a stepwise iso-strain programming experiment or stepwise stress relaxation test in order to reveal the energy storage mechanism in this thermoset network. This experiment was conducted because stress relaxation is a mechanism for energy storage during programming (19). In each step, the sample was compressed to 2% strain and then relaxed for 4 minutes. In order to elucidate the different modes for energy storage, step-wise iso-strain compression programming was also conducted. In each step of loading, the strain increases; the stress then relaxes while holding the strain constant, which completes the one loading-relaxation cycle. In each step, the sample was compressed to 2% strain and then let it relax for 4 minutes. The detailed test procedure is shown in FIGS. 1.21A-1.21B and the strain rate effect is illustrated in FIGS. 1.18A-1.18D. Subtracting the stabilized stress (stress after relaxation) from the peak stress in each step, the stress relaxation profile is obtained, as shown FIG. 1.1D. FIG. 1.1D shows the change of programming stress after relaxation, or stored stress, with programming strain. The stored stress increases as the programming strain increases, which suggests that more energy input leads to more energy storage, and thus higher recovery strain and higher recovery stress. The stored energy is calculated by the area of this relaxation stress-strain curve, which is 4.10 MJ/m³. Two distinct linear zones, separated by a transition zone, can be identified. The slope of the second linear zone, which represents the relaxed modulus of the polymer, is much higher than that of the first zone. This is a physical evidence that this thermoset network has a giant recovery stress. The three zones in FIG. 1.1D indicate that the energy storage follows two different mechanisms during the programming process. In Linear Zone I (LZ1), the energy is stored through entropy reduction. In the Transition Zone (TZ), the energy storage is through both entropy reduction and enthalpy increase, but gradually with more and more share by enthalpy as the programming strain increases. In Linear Zone II (LZ2), the energy is primarily stored by increase in enthalpy. From FIG. 1.1D, the stored energy, which is the area included by the relaxation stress-strain curve, is calculated to be 4.10 MJ/m³. Therefore, the energy output efficiency is 2.12 MJ/m³/4.10 MJ/m³=51.71%.

The energy storage mechanism can also be understood at the molecular level. The synthesized EPON-IPD network can be treated as a continuous elastic body in rubbery state when the unreacted residual monomers and defects are neglected. From low to high energy state, only three molecular structural parameters, which are the dihedral angle, bond length, and bond angle, can be changed during the programming process (20). The dihedral angle can be changed by bond rotation; while the change in bond length and bond angle might happen by stretching, compressing or bending the chemical bonds. In general, bond angle is determined by the type of orbiters such as sp2, sp3, etc., and it is the most difficult parameter to change. Therefore, it is assumed that bond angles are constant in this study. During mechanical deformation (programming), the parameter with low energy state can be changed first, which is the dihedral angle. Each change in the dihedral angle leads to a new, ordered or aligned conformational configuration of the network, or entropy decrease, which corresponds to the LZ1 in FIG. 1.1D. With further deformation, the dihedral angle change becomes more difficult because (1) the free volume is reduced; and (2) the available conformational configurations become less. Therefore, the deformation is shifted gradually towards bond length change. Clearly, bond length changes do not render new conformational entropy changes, but they increase enthalpy. This gradual shift from entropy decrease to enthalpy increase corresponds to the TZ in FIG. 1.1D. With higher programming strain, the energy will be primarily stored by the bond length change, i.e., enthalpy increases, leading to the LZ2 in FIG. 1.1D. The bond length starts to change in TZ and change more in LZ2 are confirmed by the Raman Spectroscopy and Near Edge X-ray Absorption Fine Structure Spectroscopy (NEXAFS) as shown in FIGS. 1.22A-1.22D and FIG. 1.23, respectively.

FIGS. 1.2A-1.2B confirm enthalpy release during free shape recovery by differential scanning calorimetry (DSC) tests. Two thermal cycles were conducted for the un-deformed (control, FIG. 1.2A) and 40% compression strain programmed samples (FIG. 1.2B). To avoid the post-curing effect and to match the thermal history with the programmed sample, the as control SMP sample was heated at 170° C. for over one hour before the DSC test. The typical glass transition curve, glass transition region, and glass transition temperature can be identified in the second heating cycle. Both samples show the same glass transition region in the second heating curve, because the first heating cycle has eliminated the history of programming. For the programmed sample, a high enthalpy release is confirmed by the inverse peak presenting in the first heating curve. The release starts at the on-set point of the glass transition zone sharply. Considering both the baseline shift and the normal glass transition (see section 2.1 in the Supplementary Information and FIG. 1.9), the total specific enthalpy released by the stretching bond is −2.85 J/g. The negative sign means energy release. Considering that the density of the sample is 1.142 g/cm³, the enthalpy release density is 3.25 MJ/m³. Compared with the total energy stored in the system, which is 4.10 MJ/m³, it is found that 79.3% (3.25 MJ/m³/4.10 MJ/m³) of the energy stored is in the form of enthalpy.

FIGS. 1.3A-1.3B illustrate the relationship between deformation (energy input) and relaxation (energy storage) in different zones. Counter-intuitively, the compressive deformation does not shorten the bond length; instead, the bonds are stretched as shown in the schematic in FIG. 1.3B. In LZ1 in FIG. 1.1D, the deformation and relaxation are only related to the bond rotation as shown in FIG. 1.3A. FIG. 1.3A shows the energetical evolution corresponding to linear zone I (LZ1), transition zone (TZ) and linear zone II (LZ2). Deformation excites the energy to a higher level, most likely an unstable energy state; and after structural or stress relaxation, retreats to a local lower energy level, leading to meta-stable state. For example, in the LZ2, deformation excites the rotation energy level from E₅ to E₆, and relaxation retreats the energy level in terms of bond enthalpy to E₁′. FIG. 1.3B shows the structural and conformational evolution corresponding to LZ1, TZ and LZ2. The blue springs represent rotating bonds and the green springs represent stretching bonds. The dashed circles are the possible locally meta-stable positions for the rotating bonds. Under loading 1, only bond rotation happens during both deformation and relaxation. Under loading 2, which is larger than loading 1, both bond rotation and stretching can happen during the deformation. However, the stretched bonds retreat during the relaxation. Under loading 3, which is the highest loading, the stretched bond can be stabilized in a certain conformation. The simplification made here is that the rotating bonds (blue springs) are fixed length during the deformation and the relaxation. The reality is that the rotating bonds can also be stretched.

With the increase in deformation, the total energy is excited to an energy level between the bond rotation energy and bond stretch energy. Because structural relaxation accompanies deformation, the total energy, after structural relaxation, assumes its stable energy state similar to the rotational energy state, and thus the bond length returns to its original length. With further increase in deformation, the total energy will gradually assume a higher energy state, away from the rotation energy state, but towards the bond stretch energy state, which leads to the TZ in FIG. 1.1D. With even further increase in compression deformation, the stabilized total energy is more towards the bond stretch energy, which is LZ2 in FIG. 1.1D. As a result of the enthalpy increase, around 43.8 MPa of internal stress can be stored by the stretched bonds; see calculation in section 9.1.

During the compressive deformation, the polymer network is in a non-equilibrium state at any instant. The stress relaxation is coupled with deformation. At each increment of deformation, the total free energy is excited to a higher level, most likely unstable. Due to the coupling of structural or stress relaxation, the excited energy level is relaxed back to a local “energy well”, to minimize the total free energy.

FIG. 1.4A visualizes these characteristics in the programming process. During programming at temperature above the glass transition zone, the network climbs up an energy hill with local energy well (or dip) (blue line) for local, meta-stale states. At the end of programming (after cooling and unloading), a deep energy well (dashed green line) is formed and thus the network is in a locked, non-equilibrium state. (B) Recovery. Energy input, such as heating, is needed to drive the cold energy well (dashed green line) back to the hot energy well (solid blue line) and help the CSBs (red circles) jump out of the final energy well, roll down the energy hill, and achieve shape recovery without external constraint, or stress recovery with external constraint.

Each instantaneous non-equilibrium state is regarded as a locally high energy state and each instantaneous equilibrium state is regarded as a locally low energy state, the so called meta-stable state. This can be demonstrated by an analogy of a ball resting on an energy hill with many “energy wells or dips”. The physical meaning for the movement of the ball can be understood as a change of the conformation or structure. Hence, the ball is named as a conformational or/and structural ball (CSB). Each apex of the well corresponds to a local high energy state (non-equilibrium); each valley of the well corresponds to a local low energy state (equilibrium). At each instant of deformation, the ball is excited to the apex, leading to non-equilibrium; after structural relaxation, the ball retreats to the bottom of the nearest valley, achieving local energy minimization, so that the network is in a meta-stable state. Theoretically, the real profile of the locally high or low energy state is continuous because of the numerous conformations available in the network. Moreover, each energy well should be extremely narrow. To visualize and simplify the idea for further discussion, the “well-shaped” discontinuous energy states are illustrated in FIG. 1.4A.

FIG. 1.4A also shows how the energy is stored and how the shape is fixed during the programming process. Microscopically, the heat absorption enhances the motion of electrons and reduces the electron cloud density. Consequently, the deformation can be applied more easily and higher energy level can be achieved. When the temperature drops while maintaining the programming strain, the electrons localize to the associated atoms and this meta-stable conformation or structure of the network is frozen by the amplified energy well (the dotted green line in FIG. 1.4A). CSBs will locate at the bottom of the new cold energy well. Because the depth of the energy well is enlarged, the CSBs are difficult to jump out of the cold well without a sufficient energy input. Therefore, the temporary shape is fixed. When the temperature is lower than the glass transition zone, the bonds are not easily rotatable due to the lack in free space. Although the stretched bonds, which contain enthalpy, try to return the network to their original configuration after cooling and unloading, their energy is not sufficient to overcome the energy barriers formed by the surrounding neighbors. Hence, the enthalpy is stored in the stretched bonds.

FIG. 1.4B shows the shape recovery process. Energy input, such as heating, is needed to drive the cold energy well (dashed green line) back to the hot energy well (solid blue line) and help the CSBs (red circles) jump out of the final energy well, roll down the energy hill, and achieve shape recovery without external constraint, or stress recovery with external constraint. For the free shape recovery, the cold energy well (the dotted green line) gradually gains energy and switches back to the hot energy well (the solid blue line) when the programmed network is reheated. Once a critical temperature is achieved, here the onset point of the glass transition zone, some bonds become rotatable. The CSBs are gradually lifted from the bottom of the well. The stretched bonds will attempt to contract and release their enthalpy by rotatable bonds into the whole continuous network. With further increase in temperature (energy input), the CSBs are lifted to the edge of this energy well by the stretched bond. If the absorbed energy of CSBs is greater than the energy barrier of the energy well and the network is not constrained externally, the CSBs can overcome the energy barrier and plunge back to the lower energy well. Eventually, CSBs will stabilize at the ground energy state. Macroscopically, the network restores the permanent shape, suggesting completion of the free shape recovery.

The stress recovery can also be discussed based on this energy well model. If the network is confined, the CSBs will stay at the edge of the last energy well (the deepest blue energy well) formed at the end of programing in FIG. 1.4A and generate the recovery stress. This recovery stress can be separated into two parts: the thermal stress and the memorized stress. The thermal stress is generated by the more strenuous movement of electrons in space. This drives the green colored energy well (cold) back to the blue colored energy well (hot) in FIG. 1.4B. The memorized stress can be further separated into two categories. The first category is generated by the micro Brownian motion which is related to the entropy. The second category is generated by the retreat of bond length which is enthalpy related. During the reheating, in the glassy state, the thermal stress plays a major role. Once the temperature comes to the onset point of the glass transition zone, the memorized stress starts to release. For entropy, it generates recovery stress by micro Brownian motion; for enthalpy, the bond length shortening applies forces to rotatable bonds, and accelerates the velocity of micro Brownian motion to even higher energy level. The increased velocity, or kinetic energy, will transfer to the boundary of the specimen contacting the test machine, to produce the impact force or recovery stress, similar to gas motion in a container. In the energy well model, the stored stress highly depends on the depth of the final energy well (deepest blue well). The deeper the energy well, the more the energy can be stored and the higher the recovery stress is.

In summary, the energy and recovery stress in the rigid thermoset network can be stored by bond rotation and bond length change during programming, primarily by enthalpy increases. The stored energy or stress is locked by the valley of the cold energy well after programming. Reheating excites the CSBs jumping out of the energy well, and rolling down the energy hill, leading to either shape recovery, if no constraint is applied, or recovery stress, if constraint is applied and CSBs will stay at the edge of final energy well. The value of the recovery stress and the energy stored by deformation is highly related to the depth of the final cold energy well formed at the end of programming. To enhance the recovery stress, enthalpy storage in terms of bond length changes is critical. Therefore, steric hindrance or interaction between the molecular segments need to be strengthened; see detailed discussion in section 9.1. This will drive more energy storage in enthalpy form and reduce the relaxation during recovery, achieving higher recovery stress and energy output. Some approaches such as choosing monomers with high steric hindrance, using nano- or micro-fillers, employing double or multiple networks, molecules with not-easy-to-rotate structural element, etc., can be used; see discussion on some other systems in section 1 of Supplementary Information.

Methods

Synthesis of High Enthalpy Storage Thermoset Shape Memory Polymer. Commercially available epoxy (EPON 826, DuPont, USA) and a rigid isophorone diamine (IPD), named as 5-Amino-1,3,3-trimethylcyclohexanemethylamine (Sigma-Aldrich, USA) are selected as the two components of the thermoset network. Each 100 g EPON 826 was reacted with 23.2 g IPD to balance the stoichiometry. The reagents were mixed by a mechanical mixer for two minutes at room temperature, and then were placed into a rectangle Teflon mold. The air bubbles were extracted by vacuum at room temperature. After one hour curing under 150° C., a thermoset network was obtained.

Differential Scanning calorimetry (DSC) Test. The DSC test was performed by DSC 4000 (PerkinElmer) for the investigation of the thermal behavior of the synthesized polymer network and the enthalpy release for programmed sample. The temperature scan was conducted as following steps: (1) equilibrate at 30° for three minutes, (2) heat to 170° C., (3) equilibrate at 170° C. for three minutes, (4) cool down to 30°, and (5) equilibrate at 30° for three minutes. Then the heating and cooling cycle is repeated from step 2 to step 5. All heating and cooling rates were controlled as 10° C./min.

Dynamic Mechanical Analysis (DMA) and Thermal Expansion Test. The thermomechanical property of the synthesized polymer network was analyzed by a TA Instruments Q800 Dynamic Mechanical Analyzer. Using the multi-frequency mode, the three-point bending test was carried out with fixed displacement. The temperature was scanned at a rate of 10° C./min. The thermal expansion behavior was also measured by the DMA under the controlled force mode. The fixture was changed to the tensile clamps. The cyclic temperature was scanned from −25° C. to 180° C.

Free Shape Recovery Test. The sample was prepared into a cuboid and compressed by the Mechanical Testing System (MTS) QTEST 150 machine for 40% of strain at 170° C. After the sample was cooled down to room temperature and unloading, it was placed back into the oven and was heated up to 170° C. to trigger the free shape recovery.

Fully Constrained Stress Recovery. The fully constrained recovery stress was tested by the specimens programmed by 45% compressive strain. The test was conducted by the MTS QTEST 150 machine for 8 hours. Before placing the programmed sample into the oven, the inside environment of the oven has been stabilized at 170° C. for one hour.

Relationship between Recovery Stress and Recovery Strain. A fully constrained recovery stress test for samples programmed by 45% strain was used to obtain one boundary point in the recovery stress-recovery strain curve, here zero recovery strain. The value of the recovery stress was measured after the stress was stabilized for 1.5 h at 170° C. Another boundary point is the free shape recovery test, here zero recovery stress. The samples were allowed to recovery free of constraint in the oven at 170° C. for half an hour. For other points in the recovery stress-recovery strain curve, the clamp of the MTS machine was positioned to allow 2.5%, 7.5%, 12.5%, 17.5%, 22.5%, and 32.5% recovery strains, respectively. All the tests were conducted at 170° C. for 30-40 minutes to obtain stabilized recovery stress. The exact recovery time was determined by the variation of the stress. When the change of the recovery stress was less than 0.01 MPa in 10 minutes, the value was taken and the test was stopped. The whole process was repeated for three different samples.

Relaxation Behavior at Different Temperature Zones. The relaxation test was conducted at four different temperatures, which were 120° C., 155° C., 170° C. and 175° C. All samples were compressed to 40% strain, and then the deformation was maintained to let the relaxation occur. All relaxation data were normalized by the peak stress, σ₀, at the end of compression.

Stepwise Iso-strain Compression-Relaxation Test. The sample was equilibrated in rubbery state, which was 175° C., before compression. In each step, two percent compressive strain was applied, and then relaxation was allowed for four minutes. The sample was compressed for a total of forty-four percent of strain. This test was conducted by the MTS QTEST 150 machine with an assembled oven controlled by a Eurotherm Controller (Thermodynamic Engineering Inc. Camarillo, Calif.).

Raman Spectroscopy. The measurements for the samples programmed by different strains were performed by LABRAM integrated Raman spectroscopy system manufactured by Johin Yvon Horiba. The 1 mW He—Ne Laser was used as the excitation probe and the wavelength was 632.81 nm. Both focusing and collecting the backscattered light were carried out by a 10× objective lens. The chemical shift was scanned from 800 cm⁻¹ to 1300 cm⁻¹.

Near Edge X-ray Absorption Fine Structure (NEXAFS) Spectroscopy. The C 1s K-edge spectrum was collected and used for the analysis of carbon involved bonds. The first peak was identified as the C 1s→π* (C═C) peak at 285.4 eV by polystyrene. The spectrum collection was carried out by the GEOL 7900 X-ray absorption spectrometer associated with the low energy beamline from the synchrotron located at the Center for Advanced Microstructures and Devices (CAMD), Baton Rouge. The grounded polymer powder was mounted on the copper tape as the testing sample. The compressed polymer network by different strains was milled by sandpaper gently in a −20° C. environment to reduce the heat produced by friction.

### Example 1 References

1. Lendlein, S. Kelch. Shape-memory polymers. Angew. Chem. Int. Ed. 41, 2034-2057, (2002).
2. Liu, H. Qin, P. T. Mather. Review of progress in shape-memory polymers. J. Mater. Chem. 17, 1543-1558 (2007).
3. M Ratna and J. Karger-Kocsis. Recent advances in shape memory polymers and composites: a review. J. Mater. Sci. 43, 254-269 (2008).
4. W. M. Huang, Z. Ding, C. C. Wang, J. Wei, Y. Zhao, H. Purnawali. Shape memory materials. Mater. Today 13, 54-61 (2010).
5. J. S. Leng, X. Lan, Y. J. Liu, S. Y. Du. Shape-memory polymers and their composites: stimulus methods and applications. Prog. Mater. Sci. 56, 1077-1135, (2011).
6. J. L. Hu, Y. Zhu, H. Huang, J. Lu. Recent advances in shape-memory polymers: structure, mechanism, functionality, modeling and applications. Prog. Polym. Sci. 37, 1720-1763, (2012).
7. H. Meng, G. Li. A Review of stimuli-responsive shape memory polymer composites. Polymer 54, 2199-2221 (2013).
8. Q. Zhao, H. J. Qi, T. Xie. Recent progress in shape memory polymer: new behavior, enabling materials, and mechanistic understanding. Prog. Polym. Sci. 49-50, 79-120 (2015).
9. M. D. Hager, S. Bode, C. Weber, U. S. Schubert. Shape memory polymers: past, present and future developments. Prog. Polym. Sci. 49-50, 3-33 (2015).
10. P. J. Roth, A. B. Lowe. Stimulus-responsive polymers. Polym. Chem. 8, 10-11 (2017).
11. Lendlein, R. Langer. Biodegradable, elastic shape-memory polymers for potential biomedical applications. Science 296, 1673-1676, (2002).
12. Lendlein, H. Jiang, O. Jünger, R. Langer. Light-induced shape-memory polymers. Nature 434, 879-882, (2005).
13. M. Ma, L. Guo, D. G. Anderson, R. Langer. Bio-inspired polymer composite actuator and generator driven by water gradients. Science 339, 186-189, (2013).
14. X. J. Han, Z. Q. Dong, M. M. Fan, Y. Liu, J. H. Li, Y. F. Wang, Q. J. Yuan, B. J. Li, S. Zhang. pH-Induced Shape-Memory Polymers. Macromol. Rapid Communi. 33, 1055-1060, (2012).
15. Y. Sakata, S. Furukawa, M. Kondo, K. Hirai, N. Horike, Y. Takashima, H. Uehara, N. Louvain, M. Meilikhov, T. Tsuruoka, S. Isoda, W. Kosaka, O. Sakata, S. Kitagawa. Shape-memory nanopores induced in coordination frameworks by crystal downsizing. Science 339, 193-196, (2013).
16. R. Mohr, K. Kratz, T. Weigel, M. Lucka-Gabor, M. Moneke, and A. Lendlein. Initiation of shape-memory effect by inductive heating of magnetic nanoparticles in thermoplastic polymers. PANS 103, 3540-3545 (2006).
17. P. Miaudet, A. Derr& M. Maugey, C. Zakri, P. M. Piccione, R. Inoubli, P. Poulin. Shape and temperature memory of nanocomposites with broadened glass transition. Science 318, 1294-1296, (2007).
18. G. Li, A. Shojaei. A viscoplastic theory of shape memory polymer fibers with application to self-healing materials. Proc. Roy. Soc. A 468, 2319-2346, (2012).
19. G. Li, A. Wang. Cold, warm, and hot programming of shape memory polymers. J. Polym. Sci. Part B: Polym. Phys. 54, 1319-1339, (2016).
20. P. B. Bowden. The elastic modulus of an amorphous glassy polymer. Polymer 9, 449-454 (1968).

### Example 1 Materials and Methods (Supplemental)

1. Synthesis of High Enthalpy Storage Thermoset Shape Memory Polymer

Due to the attractive potential as a mechanical actuator in future structural applications, a two-component thermoset network was chosen as the representative model polymer. To uncover the relationship between the conformational, structural, energetical and mechanical characteristics at molecular level, a pure polymer network without reinforcing filler is an appropriate object. Commercially available epoxy (EPON 826, DuPont, USA) was used as the first component in the network. To enhance the enthalpy storage, intense steric hindrance is necessary to construct a stiff network. To prevent from losing stoichiometry during the reaction, a high reacting efficiency is required. Therefore, a rigid isophorone diamine (IPD), named as 5-Amino-1,3,3-trimethylcyclohexanemethylamine (Sigma-Aldrich, USA), was selected as the other component in this network. Because the functionality of epoxy is two while the functionality of diamine is four, each 100 g EPON 826 was reacted with 23.2 g IPD to balance the stoichiometry. The reagents were mixed by a mechanical mixer for two minutes at room temperature, and then were placed into a rectangle Teflon mold. The air bubbles were extracted by vacuum at room temperature. After one hour curing under 150° C., a thermoset network was obtained.

The reagents are shown in FIG. 1.5 and the reaction pathways are illustrated in FIGS. 1.6A-1.6B, respectively.

Although not intended to be bound by theory, it is believed that the system has a certain synthetic flexibility. It is likely that diamines with rigid cyclic structure which provides the large steric hindrance, such as methyl groups, are potential molecules. They are possible to help the formed thermoset network to store the energy as enthalpy during programming. This catalog of potential molecules are listed in the FIG. 1.7A-1.7C. Moreover, the poly-cyclic and heterocyclic diamines with the groups that can provide steric hindrance are also considered as potential candidates as shown in FIG. 1.7B as the second catalog. In summary, if the amines have a rigid center, such as cyclic or caged structure, and grafting by these groups may provide steric hindrance, which are the possible chemical structures for the enthalpy storage (Table 1.1). Grafting EPON epoxy onto the surface of rigid center such as carbon black, CNT or some nanoparticles, may be another way of synthesizing this type of SMPs (FIG. 1.7C).

TABLE 1.1
Additional potential molecules or molecular centers

| Name of potential molecules or | Structure of potential molecules or |
|---|---|
| molecular center | molecular center |
| 2,5-Diaminotoluene | 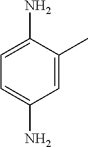 |
| 4,4-Methylenebis(2- methylcyclohexylamine | 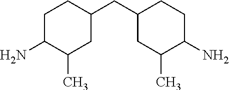 [SMILES: CC1CC(CC2CCC(N)C(C)C2)CCC1N] |
| 4,4- Methylenebis(cyclohexylamine) | 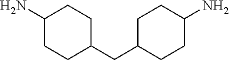 [SMILES: NC1CCC(CC2CCC(N)CC2)CC1] |
| 4,4′-Methylenebis(2- methylcyclohexylamine) | 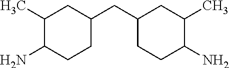 [SMILES: CC1CC(CC2CCC(N)C(C)C2)CCC1N] |
| 1,8-Diamino-p-menthane* | 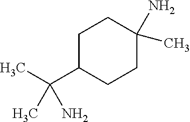 |
| Diaminonaphthalene* | 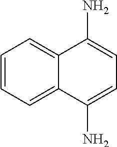 [SMILES: Nc1ccc(N)c2ccccc12] |
| | 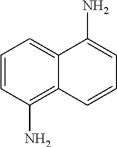 [SMILES: Nc1cccc2c(N)cccc12] |
| | 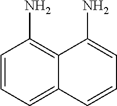 [SMILES: Nc1cccc2cccc(N)c12] |
| | 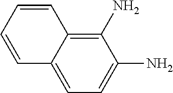 [SMILES: Nc1ccc2ccccc2c1N] |
| | 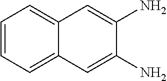 [SMILES: Nc1cc2ccccc2cc1N] |
| Diaminophenanthrene** | 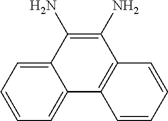 [SMILES: Nc1c(N)c2ccccc2c2ccccc12] |
| Diaminophenazine*** | 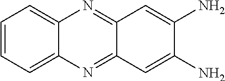 [SMILES: Nc1cc2nc3ccccc3nc2cc1N] |
| Phenylenediamine (p-, o-, m-) | 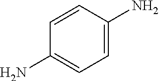 |
| | 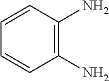 |
| | 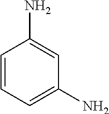 |
| N-Phenyl-o-phenylenediamine | 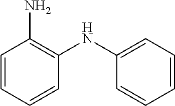 [SMILES: Nc1ccccc1Nc1ccccc1] |
| N-Phenyl-benzene-1,3-diamine | 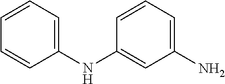 [SMILES: Nc1cccc(Nc2ccccc2)c1] |
| N-Phenyl-p-phenylenediamine | 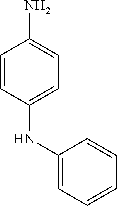 [SMILES: Nc1ccc(Nc2ccccc2)cc1] |
| N,N-Diphenyl-p- phenylenediamine | 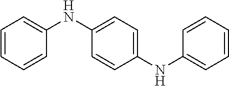 [SMILES: c1ccc(Nc2ccc(Nc3ccccc3)cc2)cc1] |
| 1,2,4,5-Benzenetetramine | 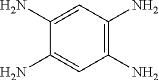 |

Note:
All of the listed potential molecular centers are related to cyclic structures. Any other molecule grafted alkyl groups onto the cyclic structures in these centers are also potential molecules that could be used in the high enthalpy storage Epoxy thermoset network.
*There are more possible diaminonaphthalene structures by positioning amino groups at different positions.
**There are more possible diaminophenanthrene structures by positioning amino groups at different positions.
***There are more possible diaminophenazine structures by positioning amino groups at different positions.

2. Method for Thermal and Thermomechanical Property Characterization of the Synthesized Polymer Network

2.1 Differential Scanning Calorimetry (DSC) Test

The DSC test was performed by DSC 4000 (PerkinElmer) for the investigation of the thermal behavior of the synthesized polymer network and the enthalpy release for the programmed sample. The glass transition range and glass transition temperature were determined by the second heating branch. The temperature scan was conducted as following steps: (1) equilibrate at 30° for three minutes, (2) heat to 170° C., (3) equilibrate at 170° C. for three minutes, (4) cool down to 30°, and (5) equilibrate at 30° for three minutes. Then the heating and cooling cycle is repeated from step 2 to step 5. All heating and cooling rates were controlled as 10° C./min. The heating branches of each cycle for the synthesized polymer and programmed polymer are plotted in FIG. 1.2A-1.2B. The whole second cycle (heating and cooling) for the synthesized polymer is plotted in FIG. 1.8.

The enthalpy calculation based on the DSC curve depends on the selection of the baseline and the endpoints. Unlike melting or crystallization, which have a clear peak and usually the associated software in the DSC machine can automatically calculate the enthalpy, glass transition (second order transition) is signified by a change in the base line, indicating a change in the heat capacity of the polymer. In order to determine the end points of the transition zone, the baselines before and after the transition are extrapolated; see the two dashed pink lines in the second heating cycle curve in FIG. 1.9. Then the glass transition zone is determined as the temperature range at the intersection of the extrapolated baselines and the line extrapolated from the linear portion during the phase transition (dashed red line in the second heating cycle in FIG. 1.9). The intersections of the dashed red line and dashed pink lines were treated as the end points of the glass transition region in this study.

Next, the baseline for the first order transition (enthalpy), i.e., the first heating cycle for the compression programmed specimen, was determined. We considered the natural physical process occurred during the first heating cycle of the programmed sample. We assumed that the inverse peak shown in the first heating cycle in FIG. 1.9 was a result of two competing physical processes. The first process was the normal glass transition, which absorbed heat, and the second process was the enthalpic energy release, which gave off heat. We also assumed that the evolution of the heat flow due to the glass transition alone was almost the same between the first and second heating cycles (Normally, there is a little difference between the first and second heating cycles due to the processing history.). We further assumed that the actual baseline of the first heating cycle for the programmed sample was separated into two parts. The first part was the glass transition and the trend of the baseline was the same as the second heating cycle “glass transition baseline” shown in FIG. 1.9. The heat flow due to the enthalpy energy release can cause the “glass transition baseline” shift to lower value. This “shifting baseline curve” shown in the FIG. 1.9 was used as the correction for the “glass transition baseline”. In this study, we assumed that the “shifting baseline curve” was a straight line connecting the two end points in the glass transition region. The combination of the “shifting baseline curve” and the “glass transition baseline” was the real baseline for calculating the energy release. Based on this real baseline, the heat release between 140° C. and 150° C. was calculated to be 2.85 J/g by integrating the heat flow curve. Based on the density of the EPON-IPD, the enthalpy release was found to be 3.25 MJ/m³.

2.2 Dynamic Mechanical Analysis (DMA)

The thermomechanical property of the synthesized polymer network was analyzed by a TA Instruments Q800 Dynamic Mechanical Analyzer. Using the multi-frequency mode, the three-point bending test was carried out with fixed displacement. The temperature was scanned at a rate of 10° C./min. The storage modulus, loss modulus and tan δ were recorded against temperature as shown in FIG. 1.10. Based on the peak of tan δ, the glass transition temperature is between 140° C. and 150° C., which is slightly lower than the result from DSC. Discrepancy between DSC and DMA measurements has been common. Instead of several MPa for most entropy driven thermoset SMPs at temperature approaching the end of the glass transition region, which is a requirement for good shape recovery, the storage modulus of our polymer network is about 65 MPa at 150° C.

The thermal expansion behavior was also measured by the DMA under the controlled force mode. The average coefficient of thermal expansion, which is equal to the strain during heating dividend by the corresponding temperature increment, is found to be 1.25×10⁻⁴° C.⁻¹ for the EPON-IPD polymer network. The serval rounds of heating and cooling cycles lead to almost the same test results. The fixture was changed to the tensile clamps. The cyclic temperature was scanned from −25° C. to 180° C. The obtained data are shown in FIG. 1.11. From the calculation based on the data presented in FIG. 1.11, the coefficient of thermal expansion, which is equal to the strain during heating dividend by the corresponding temperature increment, is 1.25×10⁻⁴° C.⁻¹ for the EPON-IPD network. The several rounds of heating and cooling cycles lead to almost the same test results.

3. Sample Preparation and Programming

3.1 Sample Preparation and Compression Programming

A perfect alignment is a significant factor for the uniaxial compression test. Hence, the cured bulky polymer network was cut and then carefully milled into a cuboid. The tolerance for each pair of parallel surfaces was less than ten micrometers. The obtained cuboid samples are shown in FIG. 1.12A. All edges of the cuboid samples are between 6.5 mm and 7.5 mm. FIG. 1.12A is an example of the cut and milled cuboid samples. FIG. 1.12B shows the sample before the compression programming, which shows that the side length of the cuboid sample is 7.01 mm. FIG. 1.12C shows the sample after programming, which is compressed by 40% strain, and the height of the cuboid sample is 4.18 mm, which translates to a shape fixity ratio of about 100%. FIG. 1.12D shows the sample after the free shape recovery, almost fully restoring the original permanent shape (the side length becomes 7.00 mm after free shape recovery as compared to original length of 7.01 mm).

Uniaxial compression programming was then conducted. Before this process, the oven, specimen and fixture have already been heated at 170° C. for over an hour, to avoid the effect of thermal expansion. The compression process is shown in FIG. 1.13. Step one represents the relationship between the stress and strain during the compressive deformation up to 45% strain at 170° C. After this, stress relaxation occurred in step two (Note: in the literature, step 1 and step 2 are usually treated as one step. For clarity of presentation, it is divided here into two steps). The step three shows the relationship between stress and temperature during the cooling process, while holding the strain constant. The air cooling process was performed by opening the door of the oven only. It is interesting to note that the unloading step, which is needed for a typical programming, is coupled with the cooling step. The load becomes zero at about 80° C., due to thermal contraction of the specimen. The compression programming was completed when the temperature drops to room temperature.

In order to understand the shape fixity capabilities of the SMP, the shape fixity ratio of the polymer at different programming strains were tested, which are listed in Table 1.2. Both the mean and standard deviation are given. Each shape fixity ratio in the table is the average of the test results of three compression programming with the same programming strain. The compression programming was conducted at 170° C.

From the test results, the shape fixity ratio is quite stable for different programming pre-strains. These shape fixity ratios are regarded as very good for such a stiff shape memory polymer. Lower programming pre-strain leads to a slightly higher deviation. This is a reasonable outcome due to the inherent instrument errors or resolutions.

TABLE 1.2
Shape fixity ratios of the samples with different
compression programming pre-strains.

| | Compressive Programming Pre-strain (%) | | | | |
|---|---|---|---|---|---|
| | 10 | 20 | 30 | 40 | 45 |
| Shape Fixity | 89.3 ± | 87.9 ± | 88.3 ± | 84.9 ± | 89.6 ± |
| ratio (%) | 5.3 | 4.0 | 3.2 | 2.1 | 2.2 |

3.2 Sample Preparation and Tension Programming

During tensile programming, the specimen with a dimension of 50 mm×14.5 mm×5 mm was mounted onto one end of the grips of the mechanical test machine before the oven was equilibrated at 170° C. for an hour. Then, the specimen was fixed by tightening the other end of the grips and tensile programming was executed. The specimen was stretched to 10% strain at 170° C. After holding for 10 minutes, the pre-stretched specimen was cooled down quickly to room temperature by spraying water onto the specimen while holding the programming strain constant. The load was then removed to fix the programmed shape.

4. Shape Memory Effect and Recovery Stress Test

4.1 Free Shape Recovery Test

Free shape recovery, as an important feature of shape memory polymers, is influenced by the deformation manner during the programming process. The polymer network in this study was an entirely continuous network. Permanent deformation rarely happens except for breaking the chemical bonds. Consequently, without defect and damage of the network, the free recovery should reproduce the permanent shape. To test this property, the sample, prepared in section 3, was compressed by the Mechanical Testing System (MTS) QTEST 150 machine for 40% of strain at 170° C. as shown in the digital photos in FIGS. 1.12B and 1.12C. After the sample was cooled down to room temperature and unloading, it was placed back into the oven and was heated up to 170° C. to trigger the free shape recovery. The photo of the recovered sample is presented in FIG. 1.12D. The free shape recovery ratio is 99.9%.

4.2 Fully Constrained Stress Recovery

The fully constrained recovery stress of a shape memory polymer indicates the potential as a mechanical actuator for future structural applications. Recovery stress is obtained by heating the network to above the glass transition temperature (in rubbery state), but without allowing any recovery strain. In order to obtain the stabilized recovery stress, the specimen was held at the recovery temperature for hours. To investigate this property, the fully constrained recovery stress test was conducted on specimens programmed by 45% compressive strain. The test was conducted by the MTS QTEST 150 machine for 8 hours, as shown in FIG. 1.1A. Before placing the programmed sample into the oven, the inside environment of the oven has been stabilized at 170° C. for one hour.

For tension programmed specimens, the recovery stress evolution with time was determined following the same procedure as compression programmed specimens; as shown in FIG. 1.14. From FIG. 1.14, one can see that the specimen with 10% tensile pre-strain can produce 5.1 MPa stable recovery stress in the rubbery state. As shown in FIG. 1.19, the tensile programming stress with 10% strain is about 7.0 MPa. With 7.0 MPa stress input, 5.1 MPa stress output (recovery stress) is reasonably high. However, because the tensile fracture strain of the polymer at 170° C. is about 12%, no tensile programming higher than 10% was performed.

To consider the effect of programming temperature on the recovery stress, two types of additional compression programming were conducted. In one type, a new compression programming at the glass transition region (150° C.) has been conducted. The pre-strain is 45%, and the fixed strain is 41.8%, which is almost the same as the fixed strain by programming at rubbery state (170° C.) with the same pre-strain 45%. The similar fixed strain makes the comparison meaningful.

In the second type of programming, three specimens were programmed into the same fixed compressive strain which was 32% at different temperatures (20° C. (glassy state), 150° C. (glass transition zone), and 170° C. (rubbery state)). All the programmed specimens, then, were recovered at 170° C. under the fully constrained conditions.

From FIG. 1.15, the peak recovery stress is about 15 MPa and the stable recovery stress is about 14 MPa. Both the peak value and the stable value are lower than 17 MPa, which is the stable recovery stress produced by the specimen programmed in the rubbery state. This is an unusual phenomenon for shape memory polymers (SMPs). For entropy driven SMPs, the recovery stress is usually higher when the programming temperature lowers, i.e., glassy state programming has higher recovery stress than programming at glass transition zone, and the least is programming in the rubbery state. This can be understood due to the temperature memory effect, i.e., the recovery temperature is lower if the programming temperature is lower. At lower recovery temperature, the stiffness of the SMPs is higher, leading to higher fully constrained recovery stress.

For the enthalpy driven shape memory EPON-IPON network, it stores energy primarily through the enthalpy increase due to the change in bond length. Therefore, how much enthalpy is stored or how many bonds are stretched during programming determine the recovery stress produced in the rubbery state. As discussed above, the bonds can be changed only when they are rotated to a very high energy level. Therefore, if some regions (segments) are not soft enough to rotate, most bonds located in the segments are not stretchable. This means that the ability for enthalpy storage is not fully taking effect. At higher temperatures, bond rotation is more likely, and thus enthalpy can be increased through bond stretch. In conclusion, for this enthalpy driven SMP, programming in rubbery state leads to higher recovery stress than that in glass transition zone, which can be further validated by FIG. 1.16.

From FIG. 1.16, it is clear that higher programming temperature can produce higher recovery stress. This is a proof of the argument that, for this enthalpy driven SMP, higher programming temperature leads to higher recovery stress. It is interesting to note that, for this SMP, temperature memory effect still exists. The specimen programmed at lower temperature recovers at slightly lower temperature. As mentioned previously, for entropy driven SMPs, this may lead to higher recovery stress for specimens programmed at lower temperature. For this enthalpy driven SMP, although this effect still exists, programming at lower temperature still leads to lower recovery stress. This is an evidence of enthalpy dominance in this SMP system.

4.3 Relationship Between Recovery Stress and Recovery Strain

A significant advantage for shape memory polymers, as compared to shape memory alloys (SMAs) or ceramics, is their large recovery strain. While SMAs have a very high fully constrained recovery stress, may be in hundreds of MPa, their free recovery strain is very small, may be less than 10%. Eventually, SMPs may output comparable energy against SMAs (1). For shape memory materials, fully constrained recovery stress and free shape recovery strain are the two extreme cases of measuring their memory capability. If recovery strain is allowed, the recovery stress will be reduced. In many applications, stress recovery must be accompanied by strain recovery, such as using shape memory effect for closing wide-opened cracks in self-healing applications or as actuators. Therefore, it is highly desired that SMPs have high recovery stress with considerable recovery strain. Actually, the area generated by the recovery stress-recovery strain curve is a direct measurement of the energy output. To obtain the relationship between recovery stress-recovery strain, the recovery stress at different recovery strains is tested as follows. A fully constrained recovery stress test for samples programmed by 45% strain was used to obtain one boundary point in the recovery stress-recovery strain curve, here zero recovery strain. The value of the recovery stress was measured after the stress was stabilized for 1.5 h at 170° C. Another boundary point is the free shape recovery test, here zero recovery stress. The samples were allowed to recovery free of constraint in the oven at 170° C. for half an hour. For other points in the recovery stress-recovery strain curve, the clamp of the MTS machine was positioned to allow 2.5%, 7.5%, 12.5%, 17.5%, 22.5%, and 32.5% recovery strains, respectively. All the tests were conducted at 170° C. for 30-40 minutes to obtain stabilized recovery stress. The exact recovery time was determined by the variation of the stress. When the change of the recovery stress was less than 0.01 MPa in 10 minutes, the value was taken and the test was stopped. The whole process was repeated for three different samples, and the averaged recovery stress with one standard deviation at different recovery strains is plotted in FIG. 1.1B in the main example 1 text. From FIG. 1.1B, we can calculate the area enclosed by the recovery stress-recovery strain curve, which yields 2.12 MJ/m³. This value is comparable with some shape memory alloys (SMAs) (1), and is much higher than thermoset SMPs and typical metals reported in the literatures, suggesting good energy storage and output capability; see Table 1.3.

5. Stress Relaxation, Strain Rate Effect, and Mechanical Behavior Test

5.1 Stress Relaxation Behavior at Different Temperature Zones

At room temperature, the polymer network, which is in glassy and non-equilibrium state, will also relax to the equilibrium state although it will take a very long time. This circumstance is referred to as physical aging. At a high temperature, especially when it is close to the glass transition zone, the relaxation is accelerated significantly. Thus, to analyze the compression behavior during programming, the relaxation performance is needed. The stress relaxation test was conducted at four different temperatures, which were 120° C., 155° C., 170° C. and 175° C. All samples were compressed to 40% strain, and then the deformation was maintained to let the stress relaxation occur. All relaxation data were normalized by the peak stress, σ₀, obtained at the end of compression; see FIG. 1.17A-1.17B. Although the higher temperature softens the thermoset network more, the intense steric hindrance helps the electrons pack more tightly. Consequently, the network is stable at even higher temperatures and this is one of the reasons for the giant stress recovery at rubbery state.

TABLE 1.3
The stress release and energy output in rubbery state for typical
compression programmed pure thermoset shape memory polymers,
recovery stress and energy output of a shape memory alloy,
and energy output of typical elastically deformed metals.

| | Recovery | Real Energy | Over-Estimated | Pre-strain of |
|---|---|---|---|---|
| | Stress | Output* | Energy Output** | Compression |
| Material Type | (MPa) | (MJ/m³) | (MJ/m³) | programming |
| EPON-IPD | 17 | 2.12 | 3.82 | 45% |
| (meth)acrylate (2) | ~1.5 | N/A | ~0.23 | 30% |
| Styrene based | 0.5 | N/A | 0.13 | 50% |
| crosslinked SMP (3) | | | | |
| Epoxy (TEMBO) (4) | 0.12 | N/A | 0.05 | 80% |
| 304 stainless steel(5) | N/A | 0.10 | N/A | 1% |
| Ductile cast iron(5) | N/A | 0.46 | N/A | 2.3% |
| Red brass(5) | N/A | 0.83 | N/A | 4% |
| Shape memory | 240 | N/A | 3.96 | 3.3% |
| alloy***(6) | | | | |
| PCL-2T-MA****(7) | N/A | 1.5 | N/A | 400% |

*The real energy output is calculated by the area of the enclosed by the recovery stress-recovery strain curve for polymers. For metals, it is calculated by the elastic part of the area of stress-strain curve.
**The over-estimated energy output is calculated by the area of the right triangle determined by the fully constrained recovery stress and free shape recovery strain as the two vertexes of the right triangle.
***Tension programming (assuming modulus of elasticity of 85 GPa, and 100% recovery ratio).
****Tension programming to 400%; the 1.5 MJ/m³ energy is storage energy.

5.2 Strain Rate Effect on Stress Storage

Due to the time-dependent behavior of the polymer network, loading rate should have an effect on the relaxation behavior. We have conducted the stepwise stress relaxation test with three strain rates: 0.1 mm/mm/min, 0.25 mm/mm/min, and 0.5 mm/mm/min; see FIG. 1.18A-1.18C. As expected, the stress increases as the strain rate increases; and the relaxed stress, or stored stress, FIG. 1.18D, also increases. This is understandable because higher strain rate means shorter time for stress to relax. It is noted that, regardless of the strain rate, the three zones exist; see FIG. 1.18D. This suggests that the stress is stored by both entropy and enthalpy. However, we do see that higher strain rates lead to higher residual stress or stored stress, suggesting higher recovery stress and energy output.

5.3 Mechanical Behavior at Room Temperature

Most applications of SMPs require that they work at ambient temperature. Hence, the mechanical property at room temperature is important. SMP samples were compressed until fracture at room temperature by the MTS QTST 150 machine. The strain rate was 1 mm/min. The test results are shown in FIG. 1.19. The network shows a typical linear elasticity, yielding, strain softening, plastic flow, strain hardening, and fracture at 320 MPa.

5.4 Tensile Behavior at Rubbery State

The tensile stress-strain behavior of the SMP was also investigated at rubbery state. The specimens were fabricated into a rectangular shape with a dimension 50 mm×14.5 mm×5 mm. The strain is calculated by the gauge length of 15 mm of the specimen, which is the length between the two marks as shown in FIG. 1.20A-1.20B. The test temperature was 170° C., and the strain rate was 0.03 mm/mm/min. One can see that the polymer can only be stretched by about 12% strain before it fractures at 170° C. The peak stress or tensile strength of the SMP is about 7.1 MPa. Therefore, when we tested the tensile recovery stress of the SMP, we selected 10% strain as the tensile programming pre-strain at 170° C.

6. Stepwise Iso-strain Compression-Relaxation Test.

Temperature, as a critical parameter affecting the mechanical properties of polymers, can be separated into different regions around the glass transition. When the temperature is lower than the glass transition zone, sufficient energy input is needed to render the coordinated segmental rotation to occur. Within the glass transition zone or at even higher temperatures, the bond rotation can happen at any strain because the thermal energy has already overcome the energy barrier for segmental bond rotation. Therefore, the deformation applied is an energy source to compel the polymer network into a non-equilibrium and locally high energy state. The relaxation will happen to stabilize the total energy towards a locally low energy state simultaneously. Thus, the characteristics of the relaxation is associated with the conformational and structural evolution during deformation. However, the relaxation reflected on the testing machine is always delayed because the relaxation is time dependent. Hence, to uncover the conformational and structural variation hidden during the deformation, a stepwise iso-strain compression-relaxation test was performed as follows. The sample was equilibrated in rubbery state, which was 175° C., before compression. In each step, two percent compressive strain was applied, and then relaxation was allowed for four minutes. The sample was compressed for a total of forty-four percent of strain. This test was conducted by the MTS QTEST 150 machine with an assembled oven controlled by a Eurotherm Controller (Thermodynamic Engineering Inc. Camarillo, Calif.). The stress against applied strain and temperature are plotted in the FIG. 1.21A-1.21B. These curves clearly show the “multiple energy wells” along an ascending energy hill, i.e., deformation brings the network to a higher energy state, and relaxation brings the network back to a local lower energy state.

7. Characterization of Bond Length Change

7.1 Raman Spectroscopy

Raman Spectroscopy, as a characterization method for the vibrational energy of chemical bond, is a very useful tool for revealing the variation of the bond length (8,9). In this study, bond length is a significant parameter for enthalpy storage. After programming (rubbery state compression, cooling and unloading), a temporary configuration is fixed in the network. Whether or not the bond length has been changed can be observed by Raman Spectroscopy at room temperature. The measurements for the samples programmed by different strains were performed by LABRAM integrated Raman spectroscopy system manufactured by Johin Yvon Horiba. The 1 mW He—Ne Laser was used as the excitation probe and the wavelength was 632.81 nm. Both focusing and collecting the backscattered light were carried out by a 10× objective lens. The chemical shift was scanned from 800 cm⁻¹ to 1300 cm⁻¹. The shifting of peaks is labeled with the type of bond as shown in FIG. 1.22A-1.22D. Both qualitative and semi-quantitative result can be obtained. From this Raman Spectroscopy, no shift happens for the programmed sample with 10% pre-strain such as FIG. 1.22C, where the pre-strain locates in the LZ1 in FIG. 1.1C. Therefore, bond rotation or dihedral angle change is the only mechanism for the deformation. The peaks begin to shift towards lower frequency direction for the sample with 20% programming strain, which falls on the TZ in FIG. 1.1C, meaning that the bond length begins to be stretched. Therefore, bond enthalpy starts to increase. Larger shift occurs for samples programmed by 30%, 40%, and 45% pre-strains, indicating that the bond length is stretched more and more in LZ2 in FIG. 1.1C.

7.2 Near Edge X-Ray Absorption Fine Structure (NEXAFS) Spectroscopy

To further confirm the change of bond length, the NEXAFS technique was also used. NEXAFS as a specific element related technique can resolve the electronic structure of molecule or molecular fragments (10,11). Carbon is the main element in the synthesized polymer network. Therefore, the C 1s K-edge spectrum was collected and used for the analysis of carbon involved bonds as shown in FIG. 1.23. The first peak was identified as the C 1s→π* (C═C) peak at 285.4 eV calibrated by polystyrene. The spectrum collection was carried out by the GEOL 7900 X-ray absorption spectrometer associated with the low energy beamline from the synchrotron located at the Center for Advanced Microstructures and Devices (CAMD), Baton Rouge. The grounded polymer powder was mounted on the copper tape as the testing sample. Subsequently, the sample was anisotropic and the shifting of the peak in the spectrum was due to the variation of the bond length only. The compressed polymer network by different strains was milled by sandpaper gently in a −20° C. environment to reduce the heat produced by friction. The second and the third peaks located at 287.4 eV and 289.0 eV are peaks associated with the C—H bond in the ring. The area used in the study is the wide peak located in the energy higher than 291 eV. The carbon associated single bonds are the resonance for peaks such as C—C, C—O or C—N bond. It is seen that there is no shift between the 10% programmed sample and the control sample without programming. Therefore, the bond length of the carbon associated single bond does not change. With the increase in programming pre-strain, the peaks begin to shift towards lower energy direction, which proves that the bonds are stretched. Larger programming strain leads to larger shift in peaks, suggesting higher bond stretch, which is similar to the result by Raman Spectroscopy.

8. Enthalpy Energy Storage and Recovery Stress

8.1 Enthalpy Storage

The chemically cross-linked network in the rubbery state can be treated as a supramolecule. When the deformed subject is treated as an elastic body in rubbery state, the energy stored is described by the Mooney's equation (12-14):

$$W = {C}_{1} ( {α}_{x}^{2} + {α}_{y}^{2} + {α}_{z}^{2} - 3 ) + {C}_{2} ( \frac{1}{{α}_{x}^{2}} + \frac{1}{{α}_{y}^{2}} + \frac{1}{{α}_{y}^{2}} - 3 ) \qquad ( {S}_{1} )$$

where C₁ and C₂ are constants, αₓ², α_{y}² and a_{z}² are stretches in three-dimensional coordinate. For example, αₓ=Lₓ/Lₓ₀ where Lₓ is the length after deformation in x direction and Lₓ₀ is the original length along the x axis. If the volume is assumed to be a constant, αₓα_{y}α_{z}=1. As a simplified case, let αₓ=α, α_{y}=α_{z}=1/α^{1/2}, the retractive stress τ, given by

$$\frac{d W}{d α} ,$$

is:

$$τ = 2 {C}_{1} ( α - \frac{1}{{α}^{2}} ) + 2 {C}_{2} ( 1 - \frac{1}{{α}^{3}} ) \qquad ( {S}_{2} )$$

If α is the stretch ratio in uniaxial test by a mechanical testing machine, the retractive stress can be used as the prediction of the deformation stress applied by loading. When α is greater than 1, the sample is under tensile test. On the other hand, if the sample is compressed, the value of α is less than one. In this case, the value of τ is negative, which represents that the retractive stress turns to tension.

The first term in the right-hand side of equation S₂ is actually related to the change of conformational entropy. The change of the conformational entropy per volume (ΔS) is described by the following equation:

$$Δ S = - \frac{ρ R}{2 {M}_{j}} [ {α}^{2} + \frac{2}{α} - 3 ] \qquad ( {S}_{3} )$$

where ρ is density, R is the gas constant, and Mⱼ is the molecular weight between closest crosslinking points or chain entanglements. The associated retractive or expansive stress (σₛ) is derived by −d(TΔS)/dα as the following equation:

$${σ}_{s} = \frac{ρ R T}{{M}_{j}} [ α - \frac{1}{{α}^{2}} ] \qquad ( {S}_{4} )$$

Obviously, if let 2C₁=ρRT/Mⱼ, equation S₄ becomes the first term on the right-hand side of equation S₂; in other words, the first term on the right-hand side of equation S₂ is indeed generated by entropy change.

Although the equation S₂ can be used for many cases of polymer deformation in rubbery state, especially for rubbers, the second term on the right-hand side needs more understanding. The physical meaning of the constant C₂ in the second term of equation S₂ is not fully understood. For most rubbers, the second term functions as a correction term because the result of the first term is not far away from the test result. However, for the EPON-IPD network, if only the entropy term is used for the calculation of the retractive stress, i.e., using equation S₄ alone, the retractive stress is calculated to be σₛ=20.5 MPa when the following parameters are used: ρ=1.143×10⁻³ g·mm⁻³, R=8.314 J·mol⁻¹·K⁻¹, T=170° C.=443K, =446.29 g. mol⁻¹ and α=0.6. This retractive stress value is much lower than the corresponding programming stress as shown in FIG. 1.1C, which is about 60 MPa. Therefore, entropy alone cannot capture the energy stored in the network. It is noted that, since the functionality of EPON is two and the functionality of IPD is four, it means that each EPON molecule is shared by two IPD molecules, but each IPD molecule is shared by four EPON molecules. Therefore, the weight of the repeating unit should be defined as one EPON molecule and half IPD molecule. This repeating unit can also serve as the chain between the cross-linking points and the molecular weight is 446.29 g/mole.

Therefore, for programming strain up to 40%, mechanism other than entropy must be considered. From section 9, we will find that the stress needed to stretch the bond is about 43.8 MPa. If we combine the entropy stress 20.5 MPa and the enthalpy stress 43.8 MPa, we obtain a total stress that needed to deform the sample is 64.3 MPa, which is very close to the programming stress of about 60 MPa. Therefore, for larger programming strain, enthalpy increase is indeed a way of storing energy. From the equation S2, the second term on the right-hand side is possibly dominant more than the first term because the value of a is less than 1 in compression programming. The 1/α³ term is greater than 1/α². Therefore, the second term is likely related to enthalpy increase, or bond stretch.

From the analysis in the main body of the paper, the energy storage is still entropy dominant when the programming strain is less than 20%, which can be confirmed by equation S₄. The calculated entropic stress is 2.5 MPa and 5.7 MPa for the 10% and 20% programmed sample. They are comparable with the programming stress in FIG. 1.1C, which are 4.1 MPa and 9.0 MPa, respectively. The sample with 10% programming strain only needs a slight correction by the second term of equation S₂. The sample with 20% programming strain needs a little more correction by the second term in equation S₂ because the bond length stretching enthalpy has already begun to take effect in the transition zone.

8.2 Recovery Stress

The energy storage mechanisms in the shape memory network can be further explained by the recovery stress. Let's first assume that the energy is stored by entropy only. The recovery stress at the maximum programming strain can be estimated by the following empirical equation for the change of entropy (15):

$$\begin{matrix}Δ {S}_{S} = 5.2819 ( {ɛ}_{max} ) ( {σ}_{R} ) \\ and & ( {S}_{5} ) \\ Δ {S}_{s} = 1.4011 \frac{( tan {δ}_{max}^{2} ) {( {ν}_{j} )}^{0.661 \; 3}}{ln ( {ν}_{j} )} & ( {S}_{6} )\end{matrix}$$

where ΔS_{S} is the stored entropy, εₘₐₓ is the maximum programming strain and the σ_{R} is the associated recovery stress, tan δ is the ratio of loss modulus to storage modulus, and vⱼ is the cross-link density which equals to ρ/Mⱼ as defined in equation S₃ or S₄. The constants in equations S₅ and S₆ were obtained by curve fitting. Plugging in equation S₅ to equation S₆, the empirical equation for σ_{R} can be derived as follows:

$${σ}_{R} = \frac{1.4011 ( tan {δ}_{max}^{2} ) {( {ν}_{j} )}^{0.6613}}{5.2819 ( {ɛ}_{max} ) \times ln ( {ν}_{j} )} \qquad ( {S}_{7} )$$

By using the same parameters applied to section 8.1 and the value of tan δ being 0.77 (from the data in FIG. 1.10), σ_{R} is calculated for the 45% programmed sample, which is equal to 7.0 MPa. This value is much lower than the measured recovery stress shown in FIGS. 1.1A and 1.1B in the main text. Therefore, entropy reduction alone fails to predict the test result. Enthalpy increase can explain the difference between the measured recovery stress (about 17 MPa) and the entropic recovery stress (7 MPa).

9. Stress Needed to Change the Bond Length and Steric Hindrance

9.1 Stress Needed to Change the Bond Length

From section 8, energy storage mechanism other than entropy reduction must be considered to explain the difference between test results and model predictions. The vibrational energy associated with the chemical bond is an effective indicator for the change of the bond length such as carbon-carbon single bond. Raman spectroscopy, as the characterization technique analyzing the vibrational energy corresponding to the chemical bonds, is a powerful tool to determine the change of the bond length qualitatively. The semi-quantitative approximation can also be done by using the proportionality constant, between the change of chemical bond shift and the stress needed to cause the bond shift. The detailed theoretical explanation is as follows.

The potential energy of chemical bond during the deformation is approximated by the Morse function (16) for anharmonic oscillation:

Uₚ=Dₑ(1−e^{-b(x-x}^{₀}⁾)² (S₈)

where Uₚ is the potential energy, Dₑ is the dissociation energy which is the energy needed to break the bond. Here b is a constant that equals to \sqrt{kₑ/2Dₑ}, where kₑ is the force constant at the minimum point of this function. The term (x-x₀) is the change of interatomic distance.

The second derivative of equation S₈ provides the force constant of the oscillation as following:

k=2b²Dₑ(2e^{-2b(x-x}^{₀}⁾−e^{-b(x-x}^{₀}⁾) (S₉)

According to Tashiro (17), the chemical shift or frequency (v) is proportional to \sqrt{k}. From equation S₉, in a small range around x₀, k decreases monotonically as shown in FIG. 1.24A-1.24B. Therefore, when Δx is positive, Δv is negative and the chemical bond is under stretching. To the opposite, when Δx is negative, the force constant increases, causing the frequency shift to higher values.

Based on Rretzlaff and Wool (18), the variation of frequency (Δv) is proportional to the applied stress. In our case, the change of the chemical bond shift in the Raman spectroscopy is observed without external loading, thus it is caused by the internal stress. This internal stress is also proportional to Av.

The standard method to characterize the correlation between the Raman peak shift and the internal stress is the in-situ testing. The variation of the Raman shift should be observed during the deformation. The relationship between the peak shift and the external loading can be assumed as a linear fashion. During Raman test, the deformation is stepwise or very slow. Therefore, the internal stress is assumed the same as the external loading. Curve fitting may also be needed to estimate the precise coefficient. Based on this discussion, the EPON-IPD network also needs the coefficient for all the types of bonds. Without the in-situ Raman spectrometer associated with the mechanical deformation accessories, as a rough estimation, we turn to the equation proposed by Wei et al. (19), which links the internal stress, Raman shift, and modulus of elasticity of the materials:

$${σ}_{b o n d} = \frac{E}{1 - v} \times \frac{Δ ω}{{ω}_{0}} \qquad ( {S}_{10} )$$

where σ is the residual stress, E is the Young's modulus, v is the Poisson's ratio, Δω is the variation of the Raman shift, and ω₀ is the reference Raman peak (original peak). The Poisson's ratio for the EPON-IPD is set as 0.48, which is an acceptable value for the nearly non-compressible thermoset polymer. The variation and the reference Raman peak can be obtained by the Raman spectrum. An additional parameter is the Young's modulus of the programmed sample. Because the Raman spectrum was collected from the programmed samples at room temperature, the Young's modulus with the same condition should be tested and utilized. Hence, the programmed EPON-IPD sample with the 45% pre-strain is deformed with a very small strain as shown in FIG. 1.25. The Young's modulus of the programmed sample is estimated by the slope of the initial stress-strain curve, which is 16.0 GPa. The variation of the Raman shift for different types of bond due to the stretching is calculated and summarized in the Table 1.4.

TABLE 1.4
The variation of the Raman shift of the different
bonds due to programming to 45% strain.

| Bond type | C—H | C—C | C—O (ester) | C—OH |
|---|---|---|---|---|
| ω₀ (cm⁻¹) | 639.5 | 772 | 915.5 | 1250.6 |
| ω_{final} (cm⁻¹) | 638.7 | 770.4 | 914.7 | 1249.8 |
| Δ ω (cm⁻¹) | 0.8 | 1.6 | 0.8 | 0.8 |

It is noted that Eq. S₁₀ is based on one single type of bonds. In our SMP, it consists of several types of bonds; see Table 1.4. Because the Young's modulus in Eq. S₁₀ is for the entire network, we cannot use it to obtain the internal stress for each individual bond and then sum them up. A better way may be to use the rule-of-mixture's approach, which needs to consider the percentage of each type of bonds within the network. Therefore, Eq. S₁₀ is revised to Eq. S₁₁:

$${σ}_{interval} = \frac{E}{1 - v} \times ( \frac{Δ {ω}_{C H}}{{ω}_{CH}^{o}} \times \frac{{N}_{CH}}{{N}_{total}} + \frac{Δ {ω}_{CC}}{{ω}_{CC}^{o}} \times \frac{{N}_{CC}}{{N}_{total}} + \frac{Δ {ω}_{CO - ester}}{{ω}_{CO - ester}^{o}} \times \frac{{N}_{CO - ester}}{{N}_{total}} + \frac{Δ {ω}_{CO - Epoxy }}{{ω}_{CO - Epoxy }^{o}} \times \frac{{N}_{CO - Epo xy}}{{N}_{total}} ) \qquad ( {S}_{11} )$$

where σᵢₙₜₑᵣₙₐₗ is the stored internal stress due to programming. N stands for the number of bonds and the subscript of N means the type of bond in a representative molecular unit (repeating unit). The subscript “total” is the sum of the number of bonds for all types of bonds within the repeating unit, i.e., Nₜₒₜₐₗ=N_{CH}+N_{CC}+N_{CO-ester}+N_{CO-Epoxy}.

Next, let us count the numbers for each type of bonds in the repeating structure. This percentage is the same for the whole network when we neglect the defects and end groups. For simplification, we also neglect the repeating unit in EPON 826 because only very low portion of the EPON has the repeating unit (8.5%). We count the number of bonds per FIG. 1.26, which includes Aromatic C—H: 8; ester C—O: 4; C—OH: 2; and —C—C—: 6+(4/2)=8. All counts are straightforward except for the number of carbon-carbon single bond. Firstly, there are 6 such bonds in EPON structure which are excluding the carbon connecting the benzene ring. There are four in the IPD which are excluding the carbon belonging to cyclic hexane. Because only half of the IPD needs to be counted, the four bonds is divided by two. Consequently, the total number of carbon-carbon single bonds are eight.

Plug in all the parameters in Eq. S₁₁, we find that σᵢₙₜₑᵣₙₐₗ=43.8 MPa. Combining the entropic stress of 20.5 MPa, the total internal stress due to programming is 64.3 MPa, which is close to the programming stress of 60 MPa. It has been known from polymer physics that both entropy and enthalpy, along with other factors, contribute to energy storage (20). Again, this very rough estimation confirms that, for this new thermoset SMP, both entropy and enthalpy contribute to energy storage; however, with higher programming strain, enthalpy storage predominates.

9.2 Steric Hindrance

To prove the argument of the “steric effect”, we take four steps. Step 1, based on the knowledge of organic chemistry and the chemical networks that have already been investigated, we assume that a certain group or groups provide the significant steric effect to the EPON-IPD network. Step 2, we find a diamine molecule with the exact or very similar structure but without the groups which are assumed to supply the steric hindrance. Step 3, we react the new diamine with the EPON826 and obtain a new thermoset network. Step 4, we test the thermal property, recovery stress and the energy storage mechanism to check if our argument of the “steric effect” is correct or not.

The first three steps are illustrated as the FIG. 1.27. We assume that the groups providing the significant steric hindrance are the methyl groups in the IPD molecule including position one and position three (the ones with scissor). The ideal diamine is the molecule without these three methyl groups as shown in FIG. 1.27. By searching the available and commercialized molecules, the 1,3-Bis (aminomethyl)cyclohexane (BACH) is chosen as the model diamine because it is a very similar molecule with the ideal structure but without the high steric hindrance (methyl groups); see FIG. 1.27. To keep stoichiometry, the molar ratio of EPON and BACH is two to one.

In step 4, the thermal property of the synthesized EPON-BACH network is tested by DSC and the result is shown in FIG. 1.28. The range of the glass transition is between 140° C. and 150° C., which is a comparatively high glass transition range. This means that the EPON-BACH network is also a rigid thermoset polymer. With the same method as that used for the EPON-IPD network, the new thermoset polymer is compression programmed into 45% pre-strain as illustrated in FIG. 1.29A. The recovery stress is also investigated and the result is shown in FIG. 1.29B. The only difference here is the temperature for the programming and recovery which is 160° C., other than 170° C. for the EPON-IPD network. The 160° C. is 10° C. higher than the end-set point for the glass transition region for the EPON-BACH, which ensures that the programming and the recovery occur at the rubbery state for this new thermoset polymer.

From FIG. 1.29A, one can see that the maximum compressive stress (about 38 MPa) corresponding to the 45% pre-strain is lower than the EPON-IPD network, which is about 60 MPa, suggesting that the EPON-IPD network is stiffer. From FIG. 1.29B, the recovery stress for the EPON-BACH is only about 8.5 MPa which is much lower than the EPON-IPD network (17 MPa). This is a clear evidence that, the polymer network without the methyl groups cannot provide the steric hindrance and thus the recovery stress is much lower.

To verify the mechanism for the energy storage, the programmed EPON-BACH sample with the 45% pre-strain is characterized by DSC and the result is shown in FIG. 1.30. Different from the EPON-IPD network, no inverse peak appears during the first heating cycle. It is proved that there is no enthalpy release during the free shape recovery process. Combining with the result of the recovery stress, it is concluded that the very similar thermoset network EPON-BACH, without the methyl groups attached on the cyclohexane structure in the diamine, cannot store energy in the form of enthalpy during the programming and the recovery stress is much lower than the EPON-IPD network, which consists of the methyl groups to provide the steric hindrance. Therefore, the argument on “steric hindrance” due to the methyl groups is valid.

10. Detailed Explanation of the “Multiple Energy Well” Model

10.1 General Scheme

The concept of energy well against change of conformation is not a creation out of nothing. The potential energy changes by the rotational dihedral angle for butane and conformation for cyclohexane have been estimated for decades as the illustration shown in FIG. 1.31A-1.31C. The butane can be treated as the smallest polyethylene which is a dimer. During the rotation of a bond in the middle, the potential energy of the molecule fluctuates in a well-shape. When the methyl groups, which are electron rich groups in a butane, are closest to each other, the electron-repelling leads to the highest potential energy. The spatial position between chemical bonds is the electron acceptable space (we can call it electron acceptor or electron hole). When the electron rich group is stabilized in the space lacking electrons, the total potential energy of the molecule is reduced. Once electron rich groups find the most comfortable positions as shown in FIG. 1.31A—a and j, the potential energy touches the ground state. On the other hand, the stable positions that can still be found are local lowest potential energy states which are called metastable states as shown in FIG. 1.31A—c and e. It is obvious that the potential energy of the metastable state is higher than the ground state, and more polymer repeat units form more metastable states. For example, the metastable state in butane is 3.8 kJ/mol higher than that of the ground state. The energy evolution by free rotation of chemical bonds was first studied by Flory (21) and Tylor in 1940s (22). The “multiple energy well” model is based on this established knowledge. Nevertheless, some differences need to be pointed out. Firstly, the metastable position of bonds is not only affected by the intramolecular interaction like butane, but is also affected by the intermolecular interaction. In other words, the circumstance of the rotatable segments in a polymer network also affects the variation of the energy states. All interactions in molecular level can be generalized by electron repelling (peak of energy well) or electron stabilization (bottom of energy well) by electron acceptable space (electron acceptor) or electron vacancy space (electron hole). During the rotation of the chemical bonds, the local metastable position can be reached. The process of searching then staying at a metastable position can be imaged as the CSBs fall into an energy well. Secondly, both tension and compression cannot rotate the torsional angle to exceed the limit, which is 180 degrees. Therefore, during the programming of the polymer network, the pattern of potential energy is not symmetry as butane. Only half of the pattern can be revealed and it is kept ramping up.

10.2 Free Shape Recovery Versus Exothermic Chemical Reaction

The free shape recovery, as a spontaneous process associated with Gibbs free energy variation, has a lot of analogies compared with an exothermic chemical reaction as shown in FIG. 1.32. The classical interpretation of a chemical reaction is described as follow. Although the free energy of reactants is higher than the product, the reaction will not occur without the activation energy. Before the spontaneous process happens, the reactants need to be excited into a high energetical level by heat, light, microwave or others. The total free energy will be stabilized by the variation of the molecular structure or degree of freedom. The Gibbs free energy of reactants is higher than the products and the free energy can be separated into enthalpy part and entropy part. The enthalpic part is due to the type of chemical bonding that is changed. In shape memory effect, although the free energy of the fixed polymer network is higher than the original shape, it will not recover spontaneously without energy input. After the excitation by heating, the spontaneous transition will happen. The total energy is stabilized by the conformational and structural variation in the network during the recovering. The total free energy of the polymer network can also be separated into the enthalpic part and entropic part. The difference between these two phenomena is that the chemical bonds, regardless of reactants or products, exist naturally. The conformation or structure of the polymer network located at high energy state needs programming.

10.3 Recovery Rate

The recovery rate of SMPs during free shape recovery is a significant property for all shape memory polymers. In this “multiple energy well” model, it corresponds to the time for the CSBs to roll down to the ground state. The free recovery process can be divided into two regions. The driving force for the high-energy region is the combination of entropy and enthalpy. In this region, the CSBs will be pulled back to low energy well by the stretched bonds. Subsequently, the CSBs located at the peak of an energy well is not in an equilibrium state. In this case, the driving force from the stretched bonds is the dominant factor for controlling shape recovering rate. In the low-energy region, the driving force that helps the CSBs fall back into low energy well is entropy only. If the chance of falling into an old or new energy well is equal, the frequency of CSBs vibrating in one energy well will determine the recovery rate. These characteristics is affected by the intrinsic property of the network, the environment of rotatable bond, and the temperature.

10.4 Recovery Ratio

Although the “multiple energy well” model assumes that the polymer network contains no defect and no permanent deformation happens during the programming process, this model is capable of explaining the shape memory effect (SME) with plastic deformation by slight modification as shown in FIG. 1.33A. Even for a perfect polymer network, permanent deformation can happen such as breaking chemical bonds due to “over-programming”. It happens much more easily for physically crosslinked SMPs because the network is constructed by chain entanglements or intermolecular interaction. The shape is hardly recovered when permanent deformation occurs. In this case, the term named shape recovery ratio is employed to define the recovered shape or strain quantitatively.

As shown in FIG. 1.33B, energetic wells will break into discontinuous pieces if the permanent deformation happens. The energy absorbed when the SME is triggered will be consumed by the completed recovering part. If the rest of the energy is not able to overcome the energy gap formed by permanent deformation, the shape recovering will not happen for the residual shape (strain).

### Example 1 Supplementary References

1. G. Li. Self-Healing Composites: Shape Memory Polymer Based Structures. John Wiley & Sons, Inc., West Sussex, UK, (2014).
2. N. Lakhera, C. M. Yakachi, T. D. Nguyen, C. P. Frick. Partially constrained recovery of (meth)acrylate shape-memory polymer networks. J. Appl. Polym. Sci. 126, 82-82 (2012).
3. Wang, G. Li, Stress memory of a thermoset shape memory polymer. J. Appl. Polym. Sci. 132, 42112 (2015).
4. M. A. Di Prima, M. Lesniewski, K. Gall, D. L. McDowell, T. Sanderson, D. Campbell. Thermo-mechanical behavior of epoxy shape memory polymer foams. Smart Mater. Struct. 16, 2330-2340 (2007).
5. ASM International. Atlas of Stress-Strain Curves-2nd ed. ASM International, OH, (2002).
6. E. L. Kirkby, J. D. Rule, V. J. Michaud, N. R. Sottos, S. R. White, J. A. E. Manson. Embedded shape-memory alloy wires for improved performance of self-healing polymers. Adv. Funct. Mater. 18, 2253-2260, (2008).
7. C. L. Lewis, Y. Meng, and M. Anthamatten. Well-Defined Shape-Memory Networks with High Elastic Energy Capacity. Macromolecules 48, 4918-4926, (2015).
8. P. M. Ajayan, L. S. Schadler, C. Giannaris A. Rubio. Single-walled carbon nanotube-polymer composites: strength and weakness. Adv. Mater. 12, 750-753 (2000).
9. D. Yang, A. Velamakanni, G. Bozoklu, S. Park, M. Stoller, R. D. Piner, S. Stankovich, I. Jung, D. A. Field, C. A. Ventrice Jr., R. S. Ruoff. Chemical analysis of graphene oxide films after heat and chemical treatments by X-Ray photoelectron and micro-Raman spectroscopy. Carbon 47, 145-152 (2009).
10. G. Hahner. Near edge X-ray absorption fine structure spectroscopy as a tool to probe electronic and structural properties of thin organic films and liquids. Chem. Soc. Rev. 35, 1244-1255 (2006).
11. Koprinarov, A. Lippitz, J. F. Friedrich, W. E. S. Unger, Ch. Woll. Oxygen plasma induced degradation of the surface of poly(styrene), poly(bisphenol-A-carbonate) and poly(ethylene terephthalate) as observed by soft X-ray absorption spectroscopy (NEXAFS). Polymer 39, 3001-3009 (1998).
12. M. Mooney. A theory of large elastic deformation. J. Appl. Phys. 11, 582-592 (1940).
13. M. Mooney. The thermodynamics of a strained elastomer. I. general analysis. J. Appl. Phys. 19, 434-444 (1948).
14. M. Anthamatten, S. Roddecha, and J. Li. Energy Storage Capacity of Shape-Memory Polymers. Macromolecules 46, 4230-4234 (2013).
15. C. C. Hornat, Y. Yang, M. W. Urban. Quantitative predictions of shape-memory effects in polymers. Adv. Mater. 29, 1603334 (2017).
16. P. M. Morse. Diatomic molecules according to the wave mechanics. II. vibrational levels. Phys. Rev. 34, 57-64 (1929).
17. K. Tashiro, G. Wu, M. Kobayashi. Quasiharmonic treatment of infrared and Raman vibrational frequency shifts induced by tensile deformation of polymer chains. J. Polym. Sci. Part B 28, 2527-2553 (1990).
18. R. S. Bretzlaff, R. P. Wool. Frequency shifting and asymmetry in infrared bands of stressed polymers. Macromolecules 16, 1907-1917 (1983).
19. Q. Wei, A. K. Sharma, J. Sankar, J. Narayan. Mechanical properties of diamond-like carbon composite thin films prepared by pulsed laser deposition. Composites: Part B 30, 675-684 (1999).
20. J. J. Aklonis and W. J. MacKnight. Introduction to Polymer Viscoelasticity (2^{nd} Ed.). John Wiley & Sons, (1983).
21. P. J. Flory. Principles of polymer chemistry, Cornell University Press, Ithaca, N.Y., (1953).
22. W. J. Taylor. Average length and radius of normal paraffin hydrocarbon molecules. J. Chem. Phys. 16, 257-267 (1948).

### Example 2

Glass Fiber Reinforced EPON-IPD Polymer Composite Rebar

One challenge facing fiber reinforced polymer (FRP) rebar and steel rebar in concrete structures persists in the fact that, for bending members such as beams or slabs, cracks in the tension zone cannot be narrowed or closed. Actually, with time, the cracks will open wider and wider, due to the creep of FRP rebar and steel rebar, and concrete. The wide-opened cracks not only allow corrosion of steel rebars and increase fire and moisture hazard for FRP rebars, but also increase the deflection of the beams or slabs. Sometimes, the deflection may exceed the safety limit.

Such limitations for conventional FRP rebar and steel rebar can be overcome by using shape memory polymer (SMP)-based rebar. SMP rebars, after programming, can store the energy for a long time unless triggered for recovery. Once the cracks open wide enough, the shape recovery of the SMP rebar can be triggered, for instance by heating in-situ, or by applying electricity to the SMP rebar if conducting continuous carbon fiber is used to reinforce the SMP matrix, or the SMP matrix is filled in with conducting fillers such as carbon nanotubes, carbon blacks, etc., and the stored stress may be able to close the crack and reduce deflection.

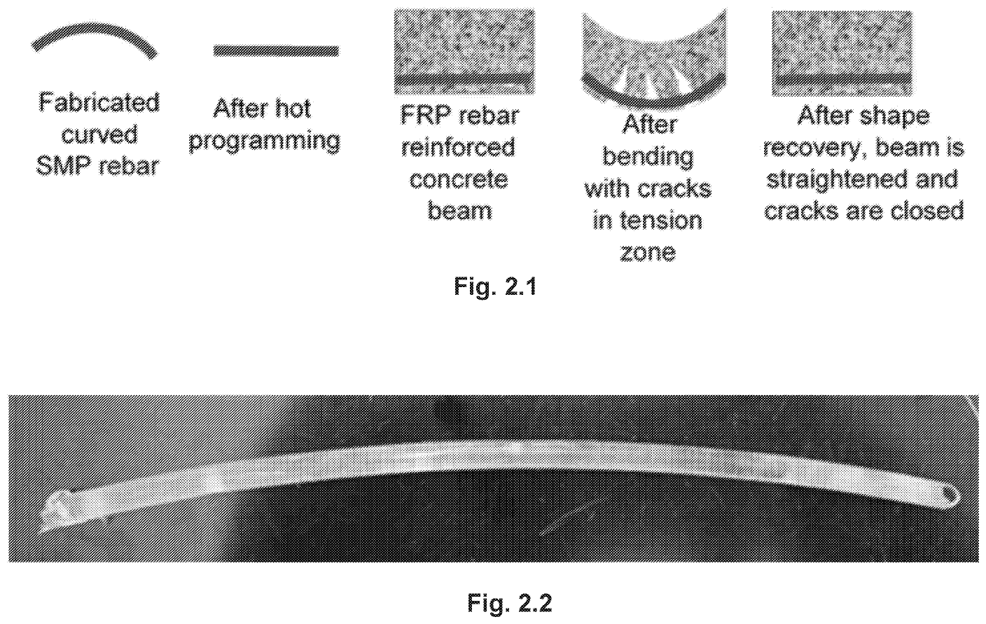

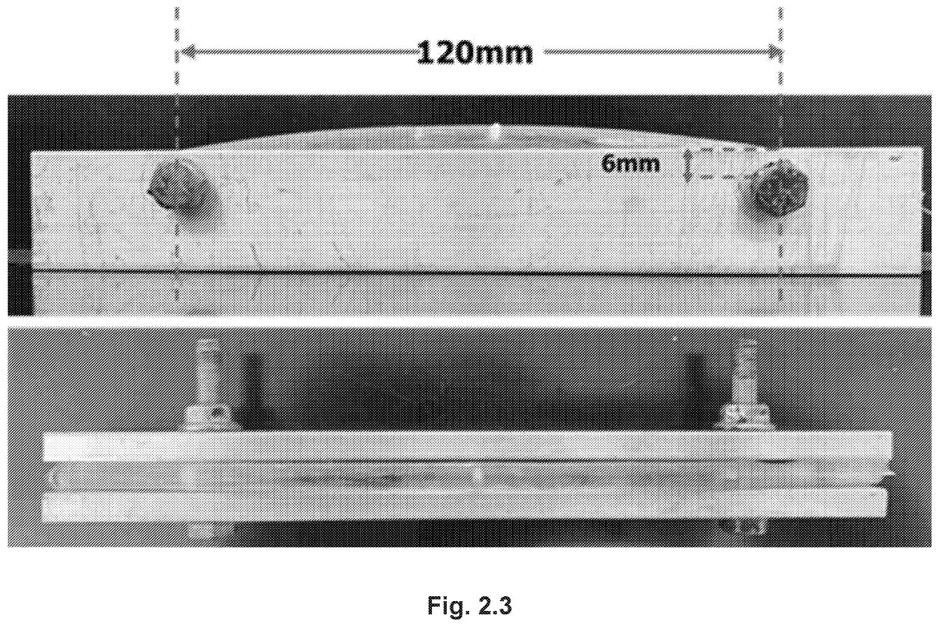

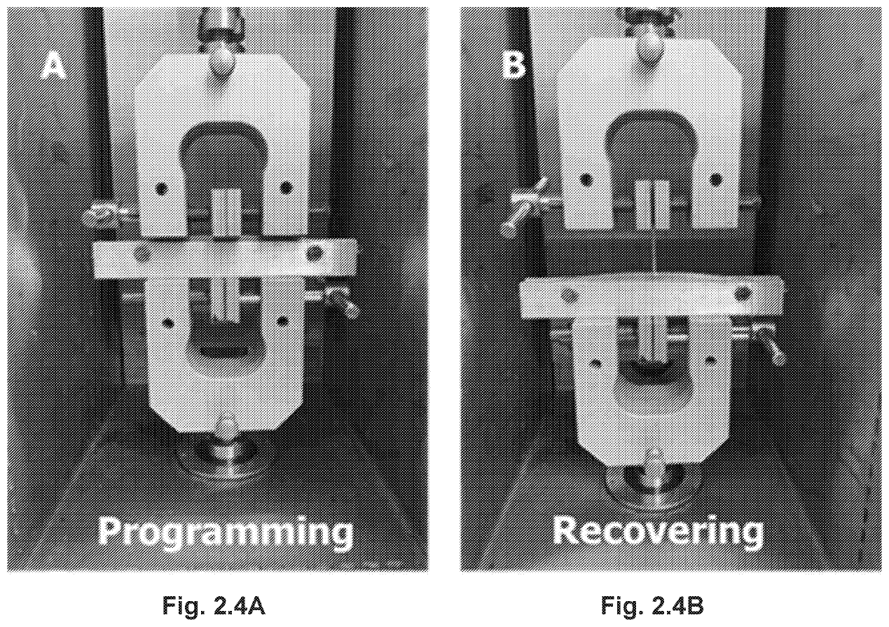

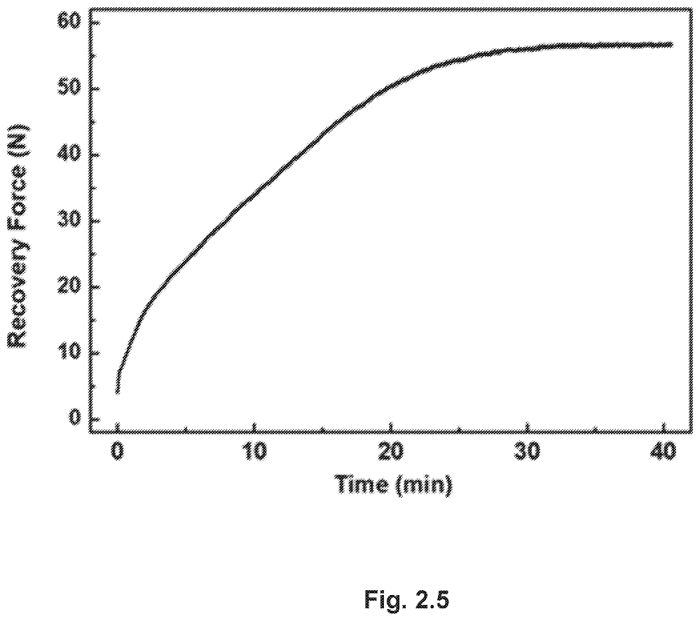

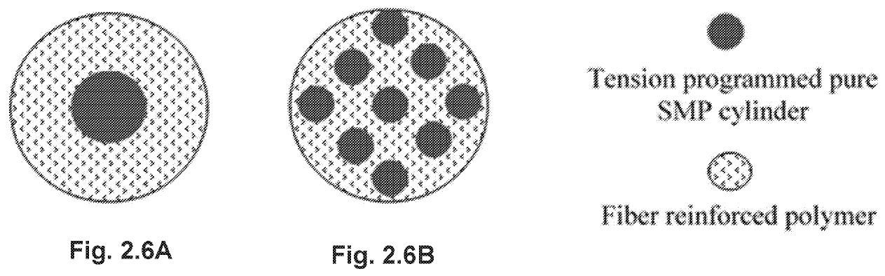

One straight forward way of preparing SMP rebar-reinforced concrete beam is to program the rebar by tension before it is embedded in the tension zone, i.e., the zone beneath the neutral axis of the beam. When triggered, the tension programmed rebar shrinks, and brings the cracked concrete surface in contact. Another way is to prepare curved SMP rebar, and program the rebar by bending, until it becomes a straight rebar. When triggered, the straight rebar tends to go back to the curved shape, leading to closure of the cracks (FIG. 2.1).

As an example, EPON-IPD is used to prepare curved glass fiber-reinforced polymer (FRP) rebar. This new SMP rebar was fabricated by a manual pultrusion method, but other fabrication methods known in the art could be employed (e.g., resin transfer molding, vacuum assisted resin infusion molding, etc.). The E-glass fiber roving used in the rebar was purchased from Fiberex Technologies (CAN). Other types of fibers, including but not limited to carbon fibers, S-glass fibers, polymeric fibers, ceramic fibers, metallic fibers, etc., can also be used. The glass fiber roving was first soaked in the EPON-IPD resin and the bubbles were removed by vacuum. One end was cured first with a steel wire hook embedded in to facilitate the pultrusion process. Then, the rest of the uncured section was pulled into a Teflon tube, which has an inner diameter of 6 mm. The volume fraction of the fiber was 50%, but fiber volume fraction as high as 70% can also be easily fabricated by the same method.

The SMP rebar was first bent into a curved shape before curing, with a curvature at the center of the rebar of 2.86/m, or radius of curvature of 0.35 m. By keeping the curvature, the rebar was cured and is shown in FIG. 2.2. The curing was completed by putting the curved rebar in an oven at 150° C. for 1 hour. Then, the cured SMP rebar was programmed by transversely compressing the rebar at 160° C. in a designed mold as shown in FIG. 2.3. The distance between the two holes is 120 mm and the distance between the top edge of the hole and the top of the mold is 6 mm, which is the diameter of the SMP rebar. After cooling down to room temperature by spreading water, the programmed SMP rebar was obtained. FIG. 2.4A shows the programming process in the oven.

The recovery force was obtained by the same mold used in the programming as shown in FIG. 2.4B. During stress recovery, the oven was first equilibrated at 160° C. for more than one hour. Subsequently, the programmed sample and the mold, which were at room temperature, were then placed in the hot oven and a gripped rod tip was allowed touch the middle of the sample, but did not apply any force to the rebar. The gripped rod was a steel bar; shown in FIG. 2.4B. The beam in such configuration is a simply supported three-point bending beam. Because no displacement was allowed during recovery, the recovery of the rebar created force, which was recorded by the MTS machine as a function of time; see FIG. 2.5.

The recovery bending stress is calculated as follow. Based on the equation:

$${σ}_{b} = \frac{M y}{1}$$

where σ_{b} is the bending stress. M is the bending moment. In this case, the rebar was a simply supported three-point bending beam, thus M=0.5×60 mm×Fᵣ, where Fᵣ is the recovering force. y is the vertical distance away from the neutral axis and, consequently, it is 3 mm. I is the area moment of inertia. We consider the cross section of the sample is a solid cylinder, hence, I=πd⁴/64. Here d is the diameter of the rebar, which is 6 mm.

From FIG. 2.5, the stabilized recovery force is 55 N. Therefore, the maximum recovery bending stress is calculated as follows:

$${σ}_{b} = \frac{M y}{I} = \frac{0.5 \times 60 mm \times 55 N \times 3 mm}{π \times {6}^{4 } {mm}^{4}} \times 64 = 77.8 MPa$$

Clearly, to further increase the recovery force, larger curvature in the fabricated SMP rebar helps, because more energy is needed to program it into a straight rod. Another way is, of course, to fabricate straight SMP rebar, and program it by tension. Although not intending to be bound by theory, because the continuous fibers in the rebar resist tension, there are potentially other ways to prepare SMP rebar. One is to prepare a pure SMP cylinder first, and program the cylinder by tension. After that, the SMP cylinder can be inserted into the center of the Teflon tube, and then the fibers, which are wetted by resin, can be pulled through the space between the SMP cylinder and the inner surface of the Teflon tube; see a schematic in FIG. 2.6A. Other lower temperature curing thermoset would need to be used such as EPON or ultraviolet (UV) curing thermoset, so that curing of the remaining fiber reinforced polymer does not trigger the recovery of the SMP cylinder. Another approach is to prepare a number of SMP cylinders and program them by tension, and then insert them into the Teflon tube in a certain pattern; see FIG. 2.6B. The space left, again, will be filled in by fiber reinforced polymer. Because the shape recovery is fully coming from the SMP, it is likely that these approaches can enhance the recovery force. Additional elements (e.g. short fibers, milled fibers, or even nanoparticles) can be added to the SMP to further increase its strength, stiffness, and recovery force, so that stronger, stiffer, and higher recovery force SMP rebar can be obtained.

### Example 3

Programmed EPON-IPD Particles Serving as Expandable Additives.

The SMP of the present disclosure, with its giant recovery stress, has many potential applications, including, but not limited to serving as proppant or expandable additive in preparing expandable cement for loss circulation control in oil and gas drilling. However, in all of these applications, the SMP needs to be used in the form of compression programmed particles. The purpose of this example is to demonstrate that the compression programmed SMP particles made from the SMPs/thermoset polymer networks of the present disclosure are expandable.

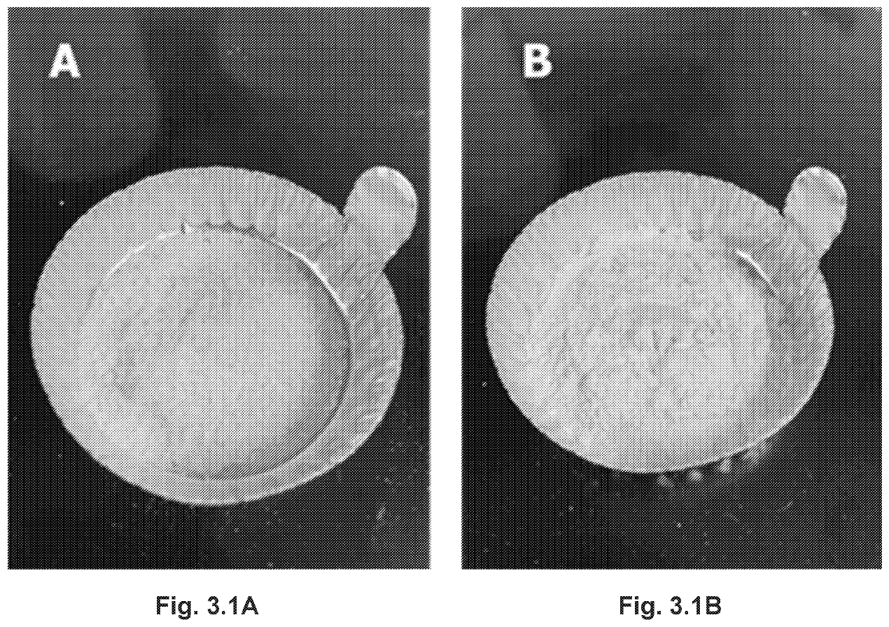

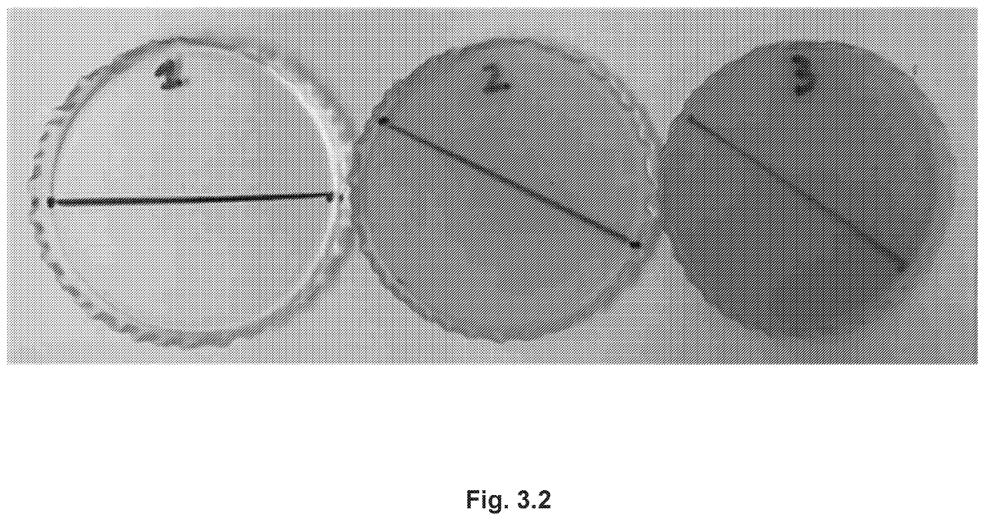

The bulky EPON-IPD was obtained first as the raw SMP (raw SMP refers to the thermoset network as described in the present disclosure prior to programming). The raw SMP block sample was uniaxially compressed at 160° C. until some cracks appeared (about 45% of compressive strain). This is for the convenience of breaking the bulky sample into smaller pieces. As could be envisioned by one of skill in the art, other methods for obtaining smaller polymer particles could be used. After cooling the compressed SMP block sample down to the room temperature, it was broken into pieces and crashed by press again into much smaller sized grains. These crashed grains were milled by a ball milling machine. Every half hour, the ball milling machine was stopped, and a sieve was used to obtained different sized particles, all the way to fine powders; see FIG. 3.1A for particles and FIG. 3.1B for powders.

We first investigated the expansion of larger sized particles down to the size of 1 mm, by adding 6% by weight of SMP particles into a cement slurry, which was made of API class-G cement with distilled water. The evaluation of the cement expansion was conducted by following API RP 10B-5 (API, 2005), which provides the standard to measure expansion of the cement sheath. Because the annular ring was fully confined from top to bottom, the expansion was linear horizontally. Following its preparation, the slurry was placed in the annular ring expansion test apparatus and the mold was taken to a curing chamber to cure under 150° C. temperature and 3000 psi (20.7 MPa) pressure for 24 hours. The percentage circumferential expansion was measured by comparing the distance of the steel pins on the mold before and after curing by using the following equation (1):

ΔL(%)=(L_{f}−Lᵢ)×0.358

where L_{f} and Lᵢ are the final and initial distance between the two pins, respectively, measured in mm.

From the test, the results are as follows: Lᵢ=12.108 mm; L_{f}=13.779 mm; and the percentage circumferential expansion ΔL is calculated to be 0.598%. It is noted that during the experiment, a small amount of cement slurry was lost, suggesting that the expansion number reported here is conservative. It is also noted that the most common desired percentage circumferential expansion in well cementing jobs is between 0.5% and 1%. Therefore, our conservative test result (0.598%) falls within the desired range. This confirms the expansion of the SMP particles in cement slurry, or its potential applications as proppant or loss circulations in oil and gas drilling, particularly for those formations that has high downhole temperatures.

To confirm the milled SMP powder is also expandable, the following experiment was performed.

Three samples were fabricated as shown in FIG. 3.2. Sample one was made of the 5 mL normal EPON-IPD resin containing no additive. Sample two was made of 5 mL EPON-IPD resin and 1.5 g of compression programmed EPON-IPD powder. Sample three was made of 5 mL EPON-IPD resin and 3 g of compression programmed EPON-IPD powder. The mixture was mixed well before the air bubbles were eliminated by vacuum. Each mixture was transferred into an aluminum weighting boat before curing. The three samples were first partially cured at 80° C. for half an hour. The partially cured samples were cooled down to room temperature and the aluminum weighting boats were peeled off. At this moment, the programmed powder was not recovered, suggesting that it was not expanded. Each sample was marked by a line passing through the center, and the length of each line was measured at room temperature; see FIG. 3.2. Subsequently, the samples were placed in an oven at 150° C. for half an hour to cure the partially cured SMP and to trigger the expansion of the embedded SMP powders. The length of the marked line for each sample was measured again after they were cooled down to room temperature. The changes of the line lengths are listed in Table 3.1.

TABLE 3.1
The change in the length of the marked line for each sample.

| | Length of the | Length of the | Change of the |
|---|---|---|---|
| | marked line at room | marked line at room | marked line lengths |
| | temperature after partial | temperature after | at room temperature |
| | curing at 80° C. | heating at 150° C. | after different |
| | (mm) for 30 minutes | (mm) for 30 minutes | thermal history (mm) |
| Sample #1 | 54.00 | 53.99 | −0.01 |
| Sample #2 | 54.09 | 54.19 | +0.10 |
| Sample #3 | 54.00 | 54.23 | +0.23 |

From Table 3.1, the pure EPON-IPD resin shrunk slightly because some post-cure happened at 150° C. On the other hand, the samples with compression programmed SMP powders expanded, and the expansion increases as the amount of compression programmed powders increase. It is concluded that the methods for preparing SMP powders, and the methods for compression programming are successful. The compression programmed SMP powders, like their bulky counterparts and larger sized particles, can expand.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. In an embodiment, “about 0” can refer to 0, 0.001, 0.01, or 0.1. In an embodiment, the term “about” can include traditional rounding according to significant figures of the numerical value. In addition, the phrase “about ‘x’ to ‘y’” includes “about ‘x’ to about ‘y’”.

It should be emphasized that the above-described embodiments of the present disclosure are merely possible examples of implementations, and are set forth only for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure.

### Example 3 Supplementary Reference

1. A. D. Taleghani, G. Li, M. Moayeri. Smart Expandable Cement Additive to Achieve Better Wellbore Integrity. ASME Journal of Energy Resource Technology, Vol. 139, No. 6, paper number 062903, (November, 2017).

1. A composition, comprising a shape memory polymer having a characteristic of having an energy stored through an enthalpy increase which is a result of stretched bonds during programming of the shape memory polymer, wherein the shape memory polymer has a recovery stress of about 15 to about 20 MPa, and wherein the shape memory polymer has an energy output of about 2.0 to about 2.5 MJ/m³, an energy output efficiency of 50% or greater, or a combination thereof.

2. The composition of claim 1, wherein the shape memory polymer is comprised of a thermoset polymer network.

3. The composition of claim 2, wherein the thermoset polymer network is a product made by a reaction of an epoxy and an amine.

4. The composition of claim 3, wherein the epoxy is a bisphenol A-based epoxy resin.

5. The composition of claim 3, wherein the amine is selected from 5-Amino-1,3,3-trimethylcyclohexanemethylamine, 1,5,5-trimethyl-1,3-Cyclohexanedimethanamine, 3-amino-4-5-6-trimethyl-Cyclohexanemethanamine, 4,6-dimethyl-1,3-Benzenedimethanamine, 5-methyl-1,3-Benzenedimethanamine, 4,4′-methylenebis[2,5-dimethyl-Cyclohexanamine], 4,4′-(1-methylethylidene) bis[2,6-dimethyl-Cyclohexanamine], 3,7-dimethyl-1,5-Naphthalenediamine 4,4′-(1-methylethylidene) bis-Benzenamine, 2,5-Diaminotoluene, 4,4-Methylenebis(2-methylcyclohexylamine, 4,4-Methylenebis(cyclohexylamine), 4,4′-Methylenebis(2-methylcyclohexylamine), 1,8-Diamino-p-menthane, Diaminonaphthalene, Diaminophenanthrene, Diaminophenazine, o-Phenylenediamine, p-Phenylenediamine, m-Phenylenediamine, N-Phenyl-o-phenylenediamine, N-Phenyl-benzene-1,3-diamine, N-Phenyl-p-phenylenediamine, N,N-Diphenyl-p-phenylenediamine, and 1,2,4,5-Benzenetetramine.

6. A thermoset polymer network, comprising a product made by the reaction of an epoxy and an amine, wherein the epoxy is a bisphenol A-based epoxy resin, wherein the amine is selected from 5-Amino-1,3,3-trimethylcyclohexanemethylamine, 1,5,5-trimethyl-1,3-Cyclohexanedimethanamine, 3-amino-4-5-6-trimethyl-Cyclohexanemethanamine, 4,6-dimethyl-1,3-Benzenedimethanamine, 5-methyl-1,3-Benzenedimethanamine, 4,4′-methylenebis[2,5-dimethyl-Cyclohexanamine], 4,4′-(1-methylethylidene) bis[2,6-dimethyl-Cyclohexanamine], 3,7-dimethyl-1,5-Naphthalenediamine 4,4′-(1-methylethylidene) bis-Benzenamine, 2,5-Diaminotoluene, 4,4-Methylenebis(2-methylcyclohexylamine, 4,4-Methylenebis(cyclohexylamine), 4,4′-Methylenebis(2-methylcyclohexylamine), 1,8-Diamino-p-menthane, Diaminonaphthalene, Diaminophenanthrene, Diaminophenazine, o-Phenylenediamine, p-Phenylenediamine, m-Phenylenediamine, N-Phenyl-o-phenylenediamine, N-Phenyl-benzene-1,3-diamine, N-Phenyl-p-phenylenediamine, N,N-Diphenyl-p-phenylenediamine, and 1,2,4,5-Benzenetetramine.

7. The thermoset polymer network of claim 6, wherein the amine is 5-Amino-1,3,3-trimethylcyclohexanemethylamine.

8. The thermoset polymer network of claim 6, wherein the epoxy has the following structure wherein n is a positive real number:

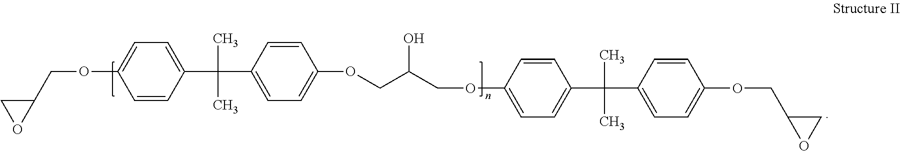

9-11. (canceled)

12. A method of making a thermoset polymer network, comprising mixing an epoxy and a diamine, and curing the mixture,
wherein the epoxy is a bisphenol A-based epoxy resin, wherein the amine is selected from 5-Amino-1,3,3-trimethylcyclohexanemethylamine, 1,5,5-trimethyl-1,3-Cyclohexanedimethanamine, 3-amino-4-5-6-trimethyl-Cyclohexanemethanamine, 4,6-dimethyl-1,3-Benzenedimethanamine, 5-methyl-1,3-Benzenedimethanamine, 4,4′-methylenebis[2,5-dimethyl-Cyclohexanamine], 4,4′-(1-methylethylidene) bis[2,6-dimethyl-Cyclohexanamine], 3,7-dimethyl-1,5-Naphthalenediamine, 4,4′-(1-methylethylidene) bis-Benzenamine, 2,5-Diaminotoluene, 4,4-Methylenebis(2-methylcyclohexylamine, 4,4-Methylenebis(cyclohexylamine), 4,4′-Methylenebis(2-methylcyclohexylamine), 1,8-Diamino-p-menthane, Diaminonaphthalene, Diaminophenanthrene, Diaminophenazine, o-Phenylenediamine, p-Phenylenediamine, m-Phenylenediamine, N-Phenyl-o-phenylenediamine, N-Phenyl-benzene-1,3-diamine, N-Phenyl-p-phenylenediamine, N,N-Diphenyl-p-phenylenediamine, and 1,2,4,5-Benzenetetramine.

13. The method of claim 12, wherein the diamine has structure I and the epoxy has structure II, wherein n is a positive real number:

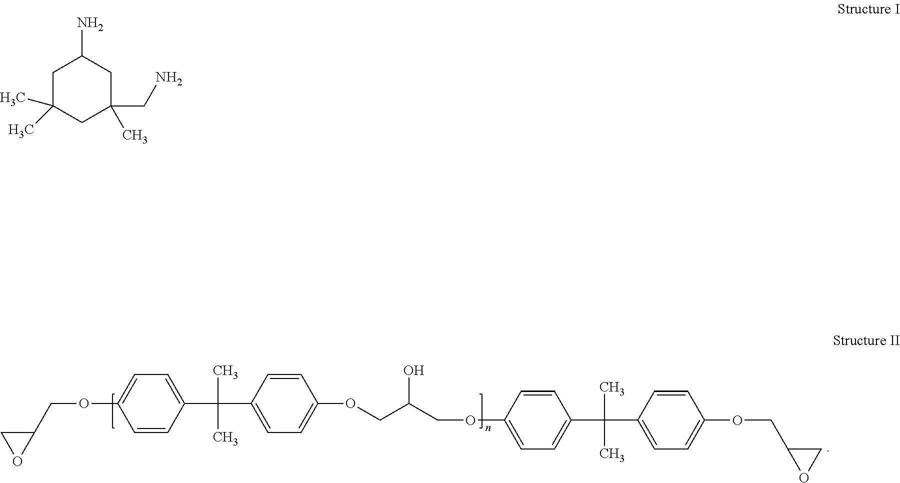

14. An article having shape memory comprising a thermoset polymer network according to claim 6, wherein the article has a recovery stress of about 15 MPa to 20 MPa.

15. The article of claim 14, further comprising fillers wherein the fillers can be selected from glass fibers, carbon fibers, polymeric fibers, ceramic fibers, metallic fibers, ceramic particles, metallic particles, polymeric particles, carbon nanotubes, nanoclays, carbon blacks, graphene, or a combination thereof.

16. The article of claim 14, wherein the article is cured, then subjected to a stress and a programming temperature to form a shape memory polymer article in a programmed state.

17. The article of claim 16, wherein the article is a shape memory polymer rebar.

18. (canceled)

19. The method according to claim 12, wherein the mixture further comprises fillers.

20. The method according to claim 12, further comprising subjecting the cured mixture to a stress and a programming temperature to form a shape memory polymer article in a programmed state.

21. The method according to claim 20, wherein the stress can be selected from tension, compression, bending, torsion, or a combination of thereof, and wherein the programming temperature is from about 150° C. to 180° C.

22. The method of claim 21, further comprising:
cooling the shape memory polymer; and
forming smaller particles of the shape memory polymer by at least one of breaking, crushing, or milling.

23. The method of claim 22, further comprising:
adding the small particles to a matrix to form a shape memory polymer composite; and
curing the shape memory polymer composite.
